(19) United States
(12) Patent Application Publication
(10) Pub. No.: US 2011/0261031 A1
(43) Pub. Date: Oct. 27, 2011

(54) METHOD OF DRIVING ELECTRO-OPTICAL DEVICE, ELECTRO-OPTICAL DEVICE, AND ELECTRONIC APPARATUS

(75) Inventor: Kota MUTO, Suwa-shi (JP)

(73) Assignee: SEIKO EPSON CORPORATION, Tokyo (JP)

(21) Appl. No.: 13/081,256

(22) Filed: Apr. 6, 2011

(30) Foreign Application Priority Data
Apr. 23, 2010 (JP) 2010-100134

(51) Int. Cl. G09G 5/00

(52) U.S. Cl. 345/204; 345/107

(57) ABSTRACT

In an electro-optical device including: a plurality of scanning lines; a plurality of data lines intersecting the plurality of scanning lines; and a plurality of pixels arranged at positions corresponding to the intersections of the plurality of scanning lines and the plurality of data lines, a method of driving the electro-optical device when refreshing only a part of the plurality of pixels includes: during a first period, selecting the scanning lines connected to part of the pixels and inputting display image data to the part of the pixels through the data lines; and during a second period, selecting the scanning lines which are not connected to the part of the pixels, wherein a period in which the respective scanning lines are selected during the second period is shorter than a period in which the respective scanning lines are selected during the first period.

### BACKGROUND

1. Technical Field

The present invention relates to a method of driving an electro-optical device, an electro-optical device, and an electronic apparatus.

2. Related Art

In recent years, in electro-optical devices (electrophoretic display devices) such as an electronic paper, there is a demand for a function (partial refresh) of refreshing only a part of the image in a state where an image or the like is displayed thereon. According to such a function, a user can perform writing on the image being displayed by operating a pen-type pointing device (see JP-A-2007-279296).

Moreover, in printers, printing quality is enhanced by printing with resolution as high as 600 dpi, for example. In display devices, image quality equivalent to the printing quality of printers is demanded.

In display devices, the image quality can be improved by increasing the resolution of images displayed on an electro-optical device by decreasing the circuit size of the respective pixels provided in the electro-optical device to thereby increase pixel density. This method increases the resolution by decreasing the circuit size of the respective pixels to increase the pixel density of the electro-optical device without changing the size of a display screen that can be displayed in the electro-optical device. In this method, however, when the total number of pixels provided in the electro-optical device increases, the number of scanning lines for writing image data to the respective pixels when displaying images with the electro-optical device also increases.

For example, a display device will be considered in which pixels are arranged two-dimensionally in the directions of rows and columns to form a display screen of an electro-optical device, and scanning lines on the row direction in the display screen are sequentially selected (scanned) one by one in the column direction from top to bottom, whereby an image of one screen (one frame) displayed in the electro-optical device is updated. In this display device, a period (one frame period) necessary for updating the image of one screen (one frame) displayed in the electro-optical device is expressed by Equation (1) below based on a period (one scanning line period) necessary for writing image data to pixels through one scanning line driving pixels on the row direction provided in the electro-optical device and the number of scanning lines (scanning line number).

Frame Period=(Scanning Line Period)×(Scanning Line Number) (1)

Here, a drive timing scheme of the electro-optical device of the related art will be described. FIG. 15 is a timing chart showing an overview of a drive timing scheme of an electro-optical device provided in a display device of the related art. In this example, it is assumed that the pixels in the electro-optical device are arranged two-dimensionally in 8 rows by 8 columns. As shown in FIG. 15, the electro-optical device of the related art is driven such that the potentials of scanning lines 1 to 8 corresponding to pixel rows in the electro-optical device are sequentially changed to a high level based on a clock signal (CLK) of a gate driver which is a scanning line drive circuit that drives the pixels. The respective pixels on the pixel row in which the scanning line is at the high level are written with image data being input to the corresponding data line, whereby an image is displayed in the electro-optical device.

In the related-art electro-optical device employing such drive timing scheme, when pixel density is increased to increase the resolution of displayed images, the number of scanning lines for scanning the respective pixels in the electro-optical device also increases. When the number of scanning lines increases, as understood from Equation (1) and FIG. 15, the frame period necessary for updating the image of one screen (one frame) displayed in the electro-optical device, namely for writing image data to the respective pixels in the electro-optical device increases. Thus, the frequency of updating the images displayed in the electro-optical device decreases. For example, in a writable display device as disclosed in JP-A-2007-279296, when the resolution of an electro-optical device is increased since it combines and displays the movement trajectory or the like of a pen-type pointing device, the updating (writing) frequency of the image produced by combining the movement trajectory of the pen-type pointing device decreases. Thus, the trajectory is not displayed smoothly. This problem is not limited to a case of inputting data externally using a pointing device but can often occur when only a part of the display is refreshed.

Therefore, when the resolution of images displayed in the electro-optical device is increased, it is necessary to prevent a reduction in the image update frequency. In order to prevent a reduction in the image update frequency, namely to decrease the frame period to increase the frame rate, as understood from Equation (1) above, it is necessary to decrease the scanning line period or the scanning line number.

However, the frame rate in the electro-optical device of the related art is proportional to the scanning line number corresponding to the resolution of the images displayed in the electro-optical device, as shown in Equation (1). Therefore, in order to increase the frame rate in a high-resolution electro-optical device, namely to decrease the frame period, it is necessary to decrease the scanning line period.

Here, a display device (electro-optical device) will be considered in which the respective pixels in the electro-optical device are pixels having the 1-Transistor 1-Capacitor (1T1C) structure, for example made up of one TFT (Thin Film Transistor) and one Capacitor (storage capacitor). In this display device, the scanning line period is a period necessary for opening (driving) the gates of TFTs provided in all pixel circuits connected to one scanning line to charge a potential corresponding to the desired image data to the capacitors. In the pixel circuits having such a configuration, it is difficult to decrease the scanning line period in which the capacitors are charged with the potential.

More specifically, the scanning line period is determined by three major factors: (1) a period in which the scanning lines and the data lines are driven to a predetermined potential; (2) the ON resistance of TFTs; and (3) a capacitance of pixel capacitors. Here, the drive period (1) is a period which is dependent on the manufacturing process of a TFT backplane, and which is dominated by an output impedance of a drive circuit (driver circuit) that drives the scanning lines and the data lines and a parasitic capacitance due to a parasitic resistance of the scanning line and data lines themselves, a coupling capacitance with other wirings, or a parasitic capacitance due to a gate capacitance of TFTs. Thus, it is difficult to easily decrease the drive period. The parasitic resistance and the parasitic capacitance of the scanning lines or data lines increase as the number of scanning lines and data lines in the display device increases. Moreover, the ON resistance of TFTs (2) depends on the manufacturing process of TFTs. Furthermore, the capacitance of capacitors (3) is difficult to decrease since a sufficient capacitance necessary for maintaining the potential of image data written to the pixels during the frame period needs to be secured.

Given the above, since the scanning line period which is the period necessary for charging the capacitors in the pixels to a potential is determined by the characteristics of the pixel circuit, it is difficult to easily decrease the scanning line period.

### SUMMARY

An advantage of some aspects of the invention is to provide a method of driving an electro-optical device capable of improving the display update frequency of the electro-optical device and to provide an electro-optical device and an electronic apparatus.

According to an aspect of the invention, there is provided a method of driving an electro-optical device, the electro-optical device including: a plurality of scanning lines; a plurality of data lines intersecting the plurality of scanning lines; and a plurality of pixels arranged at positions corresponding to the intersections of the plurality of scanning lines and the plurality of data lines, when refreshing only a part of the plurality of pixels, the method including: during a first period, selecting the scanning lines connected to part of the pixels and inputting display image data to the part of the pixels through the data lines; and during a second period, selecting the scanning lines which are not connected to the part of the pixels, wherein a period in which the respective scanning lines are selected during the second period is shorter than a period in which the respective scanning lines are selected during the first period.

According to this configuration, the electro-optical device driving method includes, during a first period, selecting the scanning lines connected to part of the pixels (partial driving area) and inputting display image data to the part of the pixels through the data lines; and during a second period, selecting the scanning lines which are not connected to the part of the pixels. Moreover, a period in which the respective scanning lines are selected during the second period can be made shorter than a period in which the respective scanning lines are selected during the first period. Accordingly, it is possible to improve the pixel update frequency (frame rate).

In the electro-optical device driving method according to the above aspect of the invention, it is preferable that the electro-optical device includes: a data line drive circuit that drives the plurality of data lines; a scanning line drive circuit that drives the plurality of scanning lines; and a drive controller that controls the data line drive circuit and the scanning line drive circuit, and the drive controller does not output a drive signal for allowing the scanning line drive circuit to select the scanning lines in a period in which the respective scanning lines are to be selected during the second period.

According to this configuration, the drive controller can be controlled so as not to output a drive signal for allowing the scanning line drive circuit to select the scanning lines in a period in which the respective scanning lines are to be selected during the second period. Accordingly, no unnecessary potential is applied to the pixels, and degradation of the display of the pixels outside the partial driving area can be prevented.

In the electro-optical device driving method according to the above aspect of the invention, it is preferable that the electro-optical device includes: a data line drive circuit that drives the plurality of data lines; a scanning line drive circuit that drives the plurality of scanning lines; and a drive controller that controls the data line drive circuit and the scanning line drive circuit, and wherein the drive controller controls the operation speed of the scanning line drive circuit so that the operation speed of the scanning line drive circuit during the second period is faster than the operation speed of the scanning line drive circuit during the first period.

According to this configuration, the drive controller can control the operation speed of the scanning line drive circuit so that the operation speed of the scanning line drive circuit during the second period is faster than the operation speed of the scanning line drive circuit during the first period. Therefore, it is possible to decrease a period for driving the pixels in order to update the pixels outside the partial driving area and to improve the pixel update frequency.

In the electro-optical device driving method according to the above aspect of the invention, it is preferable that the electro-optical device includes: a data line drive circuit that drives the plurality of data lines; a scanning line drive circuit that drives the plurality of scanning lines; and a drive controller that controls the data line drive circuit and the scanning line drive circuit, and wherein the drive controller controls the potential of data for each pixel row using the data line drive circuit so that the potential of data to be written to the pixels during the second period is not changed.

According to this configuration, the drive controller can control the potential of data for each pixel row using the data line drive circuit so that the potential of data to be written to the pixels during the second period is not changed. Therefore, for example, the data line drive circuit that drives the data lines of the pixels does not need to perform drive control of the data lines. Accordingly, it is possible to decrease the power consumption of the electro-optical device.

In the electro-optical device driving method according to the above aspect of the invention, it is preferable that the drive controller inputs data of a specific potential to the part of the pixels before controlling the potential of data for each pixel row using the data line drive circuit during the second period.

According to this configuration, the part of the pixels can be maintained at a predetermined potential before controlling the potential of data for each pixel row using the data line drive circuit during the second period. Therefore, it is possible to obviate an adverse effect on the display of the pixels such as a leaking current in the OFF state of TFTs which may occur when, in the pixels that maintain the display, the potential of the data used for the present display of the pixels is different from the potential of the data lines. As a result, it is possible to prevent the occurrence of a situation, for example, in which the display of the pixels appears as a barcode form through being affected by the potential of the data lines.

In the electro-optical device driving method according to the above aspect of the invention, it is preferable that the drive controller controls the specific potential so as to be approximately the same as the potential of a common electrode applied in common to the plurality of pixels.

According to this configuration, the potential of the data lines input to the pixels can be made approximately the same as the potential of a common electrode of the pixels during the second period. Therefore, it is possible to eliminate a potential difference applied between the source and the drain of a TFT when the TFT is in the OFF state and to prevent display degradation of the display pixels resulting from the TFT leaking current.

In the electro-optical device driving method according to the above aspect of the invention, it is preferable that a period up to the completion of the selecting of all the scanning lines during the first and second periods is fixed to a predetermined period regardless of the number of scanning lines driven during the first period.

According to this configuration, a period up to the completion of the selecting of all the scanning lines during the first and second periods can be fixed to a predetermined period regardless of the number of scanning lines driven during the first period. Therefore, it is possible to prevent the period for updating the pixel display from becoming very short, for example, when the number of scanning lines for updating the display is small. For example, when the pixels are electrophoretic elements, although the electrophoretic elements require a certain response period, since the pixel update frequency is fixed, the display update period will not be decreased to a certain extent. As a result, it is possible to prevent an increase in the load of the electro-optical device system and an increase in the power consumption resulting from the very short display update period which means the display is updated too frequently in the predetermined response period of the electrophoretic elements. Moreover, since the display update frequency is fixed, it is possible to fix the number of updates performed to obtain a target gradation and to thereby simplify the control. Furthermore, the fixed display update period enables the average voltage (effective voltage) appearing in the pixels to be maintained to be constant. Thus, it is easy to maintain a balance (DC balance) of the positive and negative voltages applied to the electrophoretic elements, and it is possible to prevent deterioration of the electro-optical device.

In the electro-optical device driving method according to the above aspect of the invention, it is preferable that a period in which the respective scanning lines are selected during the first period and a period in which the respective scanning lines are selected during the second period are changed, whereby the period up to the completion of the selecting of all the scanning lines during the first and second periods is fixed to the predetermined period regardless of the number of scanning lines driven during the first period.

According to this configuration, the period in which the respective scanning lines are selected during the first period and the period in which the respective scanning lines are selected during the second period can be changed. Moreover, the period up to the completion of the selecting of all the scanning lines during the first and second periods can be fixed to the predetermined period regardless of the number of scanning lines driven during the first period. For example, when the period in which the respective scanning lines are selected during the second period is increased, it may increase a period in which a scanning line being sequentially scanned at the time of updating the display of the pixels reaches the scanning lines connected to the part of the pixels. Thus, the period in which the scanning lines are driven during the second period is set to the shortest period allowed by the scanning line drive circuit so as to increase the period in which the scanning lines connected to the part of the pixels are driven. In this way, it is possible to decrease the period in which the scanning line being sequentially scanned at the time of refreshing the display of the pixels reaches the scanning lines connected to the part of the pixels, and to secure a sufficient period for driving the scanning lines connected to the part of the pixels.

In the electro-optical device driving method according to the above aspect of the invention, it is preferable that a blanking period is inserted before or after the first and second periods, whereby the period up to the completion of the selecting of all the scanning lines during the first and second periods is fixed to the predetermined period regardless of the number of scanning lines driven during the first period.

According to this configuration, a blanking period can be inserted before or after the first and second periods. Therefore, it is possible to easily fix the frequency of updating the display of the pixels. In particular, by inserting the blanking period at the completion time of the first period, since the period up to the completion of the second period from the start of the updating of pixels can be shortened, it is possible to make the driving of the scanning lines connected to the part of the pixels start at an early time.

In the electro-optical device driving method according to the above aspect of the invention, it is preferable that the first and second periods are repeated a plurality of times.

According to this configuration, the first and second periods can be repeated a plurality of times. Therefore, the pixel drive period can be controlled by the number of repetitions of the first and second periods. For example, when the pixels are electrophoretic elements, a voltage application period of the electrophoretic elements is 160 ms, and the pixel drive period (frame period) during the first and second periods is 40 ms, it is possible to secure the voltage application period of the electrophoretic element by repeating the frame period 4 times. Moreover, when the frame period is 20 ms, it is possible to secure the voltage application period of the electrophoretic element by repeating the frame period 8 times. As described above, even when the frame rate is increased, it is possible to secure a sufficient response period of the electrophoretic element by controlling the number of repetitions of the frame period.

According to another aspect of the invention, there is provided a method of driving an electro-optical device, the electro-optical device including: a plurality of scanning lines; a plurality of data lines intersecting the plurality of scanning lines; and a plurality of pixels arranged at positions corresponding to the intersections of the plurality of scanning lines and the plurality of data lines, when refreshing only a part of the plurality of pixels, the method including: during a first period, selecting the scanning lines connected to part of the pixels and inputting display image data to the part of the pixels through the data lines; and during a second period, selecting the scanning lines which are not connected to the part of the pixels, wherein in a period in which the respective scanning lines are selected during the second period, a drive signal is not supplied to the scanning lines.

According to this configuration, the electro-optical device driving method includes a first period in which the scanning lines connected to part of the pixels (partial driving area) are selected and display image data are input to the part of the pixels through the data lines; and a second period in which the scanning lines which are not connected to the part of the pixels are selected. Moreover, a drive signal can be controlled so as not to be supplied to the scanning lines in a period in which the respective scanning lines are to be selected are selected the second period. Accordingly, no unnecessary potential is applied to the pixels, and degradation of the display of the pixels corresponding to the scanning lines which are not connected to the part of the pixels can be prevented. Moreover, since it is not necessary to prepare writing data for the data lines corresponding to the pixels corresponding to the scanning lines which are not connected to the part of the pixels, it is possible to simplify the overall control of the electro-optical device. As a result, it is possible to decrease the power consumption of the electro-optical device.

According to still another aspect of the invention, there is provided an electro-optical device including: a plurality of scanning lines; a plurality of data lines intersecting the plurality of scanning lines; a plurality of pixels arranged at positions corresponding to the intersections of the plurality of scanning lines and the plurality of data lines; a data line drive circuit that drives the plurality of data lines; a scanning line drive circuit that drives the plurality of scanning lines; and a drive controller that controls the data line drive circuit and the scanning line drive circuit, wherein, when refreshing only a part of the plurality of pixels, the drive controller executes: during a first period, selecting the scanning lines connected to part of the pixels and inputting display image data to the part of the pixels through the data lines; and during a second period, selecting the scanning lines which are not connected to the part of the pixels, and wherein a period in which the respective scanning lines are selected during the second period is shorter than a period in which the respective scanning lines are selected during the first period.

According to this configuration, the drive controller executes: during a first period, selecting the scanning lines connected to part of the pixels and inputting display image data to the part of the pixels (partial driving area) through the data lines; and during a second period, selecting the scanning lines which are not connected to the part of the pixels. Moreover, a period in which the respective scanning lines are selected during the second period can be made shorter than a period in which the respective scanning lines are selected during the first period. Therefore, it is possible to realize an electro-optical device in which the display update frequency of the electro-optical device is improved, and the display is updated smoothly.

According to yet another aspect of the invention, there is provided an electro-optical device including: a plurality of scanning lines; a plurality of data lines intersecting the plurality of scanning lines; a plurality of pixels arranged at positions corresponding to the intersections of the plurality of scanning lines and the plurality of data lines; a data line drive circuit that drives the plurality of data lines; a scanning line drive circuit that drives the plurality of scanning lines; and a drive controller that controls the data line drive circuit and the scanning line drive circuit, wherein, when refreshing only a part of the plurality of pixels, the drive controller executes: during a first period, selecting the scanning lines connected to part of the pixels and inputting display image data to the part of the pixels through the data lines; and during a second period, selecting the scanning lines which are not connected to the part of the pixels, and wherein the drive controller does not output a drive signal for allowing the scanning line drive circuit to select the scanning lines in a period in which the respective scanning lines are to be selected during the second period.

According to this configuration, the drive controller executes: during a first period, selecting the scanning lines connected to part of the pixels and inputting display image data to the part of the pixels through the data lines; and during a second period, selecting the scanning lines which are not connected to the part of the pixels. Moreover, a drive signal can be controlled so as not to be supplied to the scanning lines in a period in which the respective scanning lines are to be selected during the second period. Therefore, no unnecessary potential is applied to pixels which are not connected to the part of the pixels. Accordingly, it is possible to prevent degradation of the display of the pixels and to simplify the overall control of the electro-optical device and realize an electro-optical device which consumes less power.

In the electro-optical device according to the above aspect of the invention, it is preferable that the pixels are made up of a display element containing a material having a memory effect.

According to this configuration, it is possible to maintain the display of the pixels. Therefore, even when only a part of the pixels in which the display is updated are refreshed, it is possible to update the display while maintaining the display of the pixels in which the display is not updated.

In the electro-optical device according to the above aspect of the invention, it is preferable that the material having the memory effect includes an electrophoretic element.

According to this configuration, it is possible to provide an electro-optical device in which the display update frequency is improved, and the display is refreshed smoothly.

In the electro-optical device according to the above aspect of the invention, it is preferable that it includes a position detector that detects the position of pixels which are in contact with a pointer when the pointer is brought into contact with an arbitrary position of the plurality of pixels, and the drive controller determines the scanning lines selected during the second period based on the position information of the pixels detected by the position detector.

According to this configuration, the position detector can detect the position of pixels in which the display input through handwriting by the user of the electro-optical device is updated. Therefore, it is possible to realize an electro-optical device in which the display of only a part of pixel areas detected by the position detector is updated.

According to still yet another aspect of the invention, there is provided an electronic apparatus including the electro-optical device according to any one of the aspects of the invention.

According to this configuration, it is possible to provide an electronic apparatus having an electro-optical device in which the display update frequency is improved, and the display is refreshed smoothly.

According to the above aspects of the invention, it is possible to improve the display update frequency of the electro-optical device.

### BRIEF DESCRIPTION OF THE DRAWINGS

The invention will be described with reference to the accompanying drawings, wherein like numbers reference like elements.

FIG. 1 is a block diagram showing a simplified configuration of a display device having an electro-optical device according to an embodiment of the invention.

FIG. 2 is a block diagram showing an example of a configuration of a common electrode power source in the display device of the present embodiment.

FIG. 3 is a block diagram showing an example of a configuration of a pixel circuit of the electro-optical device provided in the display device of the present embodiment.

FIGS. 4A and 4B are diagrams showing an example of an operation of an electrophoretic element in the electro-optical device of the present embodiment.

FIG. 5 is a block diagram showing an example of a configuration of a scanning line drive circuit of the electro-optical device provided in the display device of the present embodiment.

FIG. 6 is a flowchart showing a method of driving the electro-optical device in the display device of the present embodiment.

FIGS. 7A and 7B are diagrams showing a first image of a writing trajectory in the display device of the present embodiment.

FIG. 8 is a timing chart showing an overview of a first drive timing scheme of the electro-optical device provided in the display device of the present embodiment.

FIG. 9 is a table showing the relationship between a scanning line number in a partial driving area and an interframe interval in the first drive timing scheme of the present embodiment.

FIG. 10 is a timing chart showing an overview of a second drive timing scheme of the electro-optical device provided in the display device of the present embodiment.

FIG. 11 is a table showing the relationship between a scanning line number in a partial driving area and an H period in the second drive timing scheme of the present embodiment.

FIGS. 12A and 12B are diagrams showing a second image of a writing trajectory in the display device of the present embodiment.

FIG. 13 is a timing chart showing an overview of a third drive timing scheme of the electro-optical device provided in the display device of the present embodiment.

FIGS. 14A to 14C are diagrams showing an example of an electronic apparatus to which the electro-optical device of the present embodiment is applied.

FIG. 15 is a timing chart showing an overview of a drive timing scheme of an electro-optical device provided in a display device of the related art.

### DESCRIPTION OF EXEMPLARY EMBODIMENTS

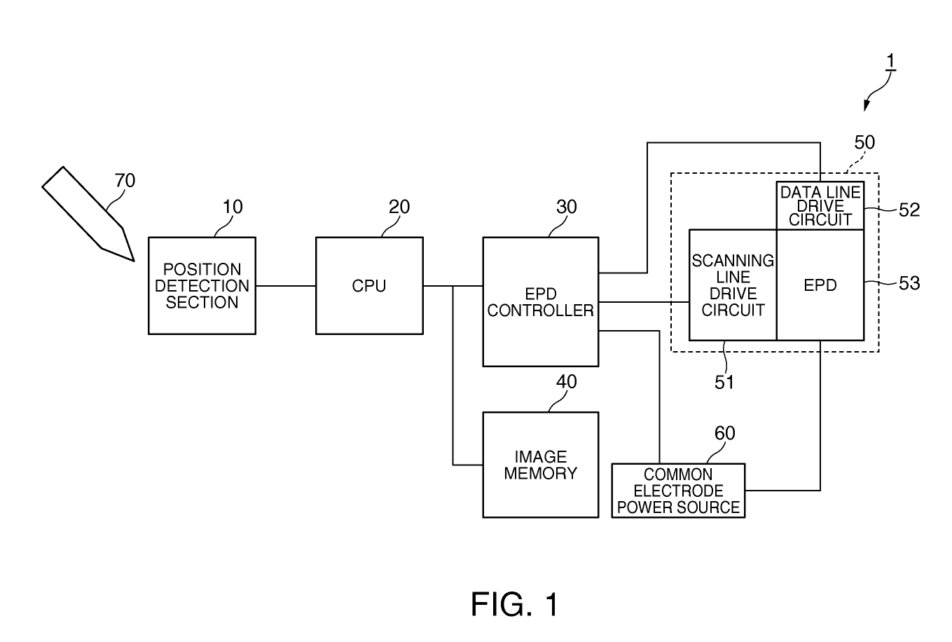

Hereinafter, embodiments of the invention will be described with reference to the drawings. FIG. 1 is a block diagram showing a simplified configuration of a display device having an electro-optical device according to the present embodiment. The display device 1 shown in FIG. 1 is an example in which an electro-optical device (electrophoretic display device) that displays images using electrophoresis is used as a display section of the display device 1. Moreover, the display device 1 enables the user of the display device 1 to add handwritten information or the like, for example. Although the display device 1 can display various kinds of data, for example, such as document data or image data on the display section, in the following description, all kinds of data including document data and the like will be referred to as “image data.”

In FIG. 1, the display device 1 includes a position detector 10, a CPU (Central Processing Unit) 20, an EPD (ElectroPhoretic Display) controller 30, an image memory 40, an EPD module 50, and a common electrode power source 60. The EPD module 50 includes a scanning line drive circuit 51, a data line drive circuit 52, and an EPD 53. Moreover, a pointing device 70 is provided as a unit to input information added by the user of the display device 1. The unit to input information added by the user may be other means, for example, such as a finger.

The display device 1 displays image data stored in the image memory 40 on the EPD module 50 which is the display section of the display device 1. Moreover, the display device 1 combines a trajectory, for example, of a handwritten line which the user of the display device 1 writes on an image being displayed on the EPD module 50 using the pen-type pointing device 70 with the image data displayed on the EPD module 50 and displays combined image data on the EPD module 50. In this way, the user of the display device 1 can recognize whether the handwritten line is written (overwritten) to the image data displayed on the EPD module 50.

The image memory 40 is a data storage, for example, such as a VRAM (Video Random Access Memory) and stores image data (hereinafter referred to as “document image data”) of a document or the like displayed (for example, printed by a printer) on the EPD module 50 of the display device 1. Moreover, the image memory 40 stores image data (hereinafter referred to as “handwritten image data”) of the trajectory of a handwritten line, created by the CPU 20 described later.

The position detector 10 detects information on the position on the EPD 53 in the EPD module 50 pointed by the pointing device 70 as coordinate information on the EPD 53. The detected coordinate information is output to the CPU 20. As a position detector of the position detection section 10, the existing position detectors, for example, using a resistive method, a capacitance coupling method, and an electromagnetic induction method are used.

The CPU 20 is a controller that controls the entirety of the display device 1. The CPU 20 controls the entirety of the display device 1 based on the coordinate information on the EPD 53 input from the position detection section 10. Moreover, when the coordinate information on the EPD 53 input from the position detection section 10 represents the coordinate of a line handwritten by the user of the display device 1, for example, the CPU 20 generates handwritten image data representing the trajectory of the handwritten line based on the coordinate information and stores the handwritten image data in the image memory 40.

Moreover, the CPU 20 outputs a drive start command for displaying image data on the EPD module 50, a display position control signal representing information (hereinafter referred to as a “display starting line”) on the start position when displaying the image data on the EPD module 50 and information (hereinafter referred to as a “display ending line”) of the ending position when displaying the image data on the EPD module 50 to the EPD controller 30. The drive start command output from the CPU 20 includes image data designation information for designating whether the image data displayed on the EPD module 50 is document image data stored in the image memory 40 or handwritten image data.

The EPD controller 30 controls the EPD module 50 and the common electrode power source 60 based on the drive start command and the display position control signal input from the CPU 20. The EPD controller 30 acquires the image data (document image data or handwritten image data) designated by the input drive start command from the image memory 40 in accordance with the drive start command input from the CPU 20 and outputs the acquired image data to the EPD module 50 as image data (hereinafter referred to as “display image data”) to be displayed by the EPD 53. Moreover, the EPD controller 30 outputs a common electrode control signal for causing power to be supplied to the common electrode of the EPD 53, which is necessary for the EPD module 50 to display the display image data, to the common electrode power source 60.

Moreover, the EPD controller 30 outputs a drive control signal for causing the display image data to be displayed by the EPD 53 based on the display position control signal input from the CPU 20 to the EPD module 50. The drive control signal which the EPD controller 30 outputs to the scanning line drive circuit 51 in the EPD module 50 is a scanning line output control signal generated based on the information of the display starting line and the display ending line, which is included in the display position control signal input from the CPU 20. Moreover, the drive control signal which the EPD controller 30 outputs to the data line drive circuit 52 in the EPD module 50 is a control signal generated based on the data of the image memory 40.

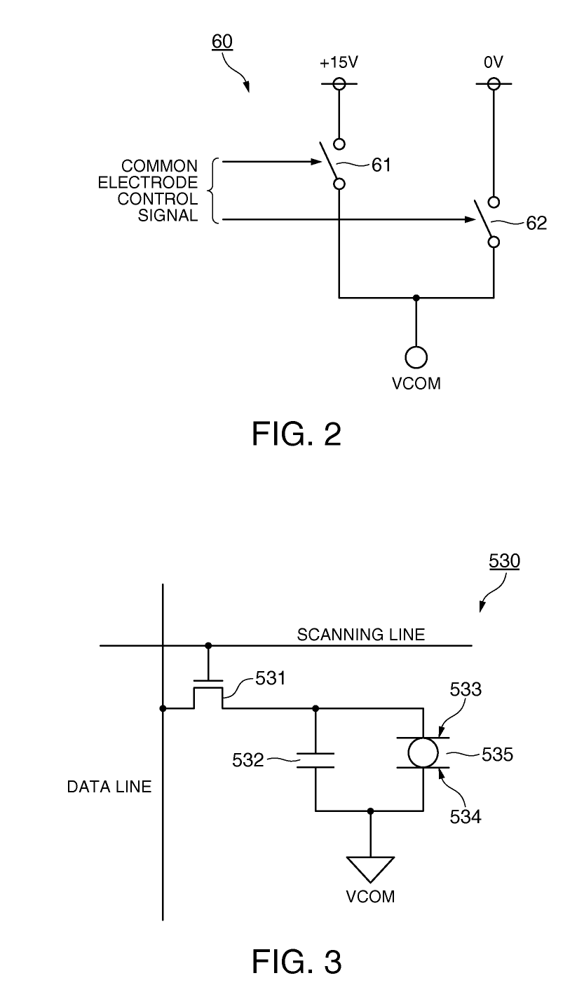

The common electrode power source 60 supplies power to the common electrode of the EPD 53 described later. The common electrode power source 60 includes changeover switches 61 and 62 as shown in FIG. 2, for example. The common electrode power source 60 switches the potential VCOM of a power supplied to the common electrode of the EPD 53 to a high level (+15 V) or a low level (0 V) in accordance with the common electrode control signal input from the EPD controller 30.

The EPD module 50 is a display section in the display device 1 of the present embodiment and is an electro-optical device which is formed of an active-matrix electrophoretic display device, for example. The EPD module 50 generates a voltage waveform corresponding to the respective pixels in the EPD 53 based on the display image data and the drive control signal input from the EPD controller 30 and displays the image data to be displayed in the display device 1 on the EPD 53 or updates the display.

The scanning line drive circuit 51 outputs a drive signal for driving the respective pixels in the EPD 53 corresponding to the drive control signal input from the EPD controller 30 to the scanning lines for sequentially selecting (scanning) the respective pixels in the EPD 53. With this drive signal, the potentials of the data lines output in accordance with the display pixel data input from the EPD controller 30 are written to the respective pixels in the EPD 53.

The data line drive circuit 52 outputs the potentials corresponding to the display image data input from the EPD controller 30 to the data lines of the respective pixels in the EPD 53. The potentials of the display image data output from the data line drive circuit 52 to the data lines are output in synchronization with the scanning of the scanning line drive circuit 51.

The EPD 53 displays the image data displayed in the display device 1 using a plurality of pixels arranged two-dimensionally in the directions of rows and columns. The EPD 53 is manufactured, for example, by attaching a TFT backplane and a conductive sheet (EP sheet) in which microcapsules including charged white and black particles (electrophoretic particles) are applied on a transparent common electrode. The TFT backplane has a configuration in which scanning lines extending in the row direction and data lines extending in the column direction are arranged in a two-dimensional matrix form, and pixels are formed at the respective intersections of the data lines and the scanning lines. The respective pixels of the EPD 53 display images through a mechanism in which the potentials of the display image data input from the data line drive circuit 52 through the data lines are maintained in accordance with the drive signal input from the scanning line drive circuit 51 through the scanning lines, and the electrophoretic elements are moved in accordance with the potentials of the maintained display image data.

Next, a configuration of a pixel circuit of the EPD 53 will be described. FIG. 3 is a block diagram showing an example of a circuit configuration of one pixel of the EPD 53 in the EPD module 50 provided in the display device 1 of the present embodiment. In FIG. 3, each pixel 530 of the EPD 53 includes a TFT (Thin Film Transistor) 531, a capacitor (storage capacitor) 532, a pixel electrode 533, a common electrode 534, and an electrophoretic element 535. With the configuration shown in FIG. 3, the respective pixels 530 of the EPD 53 have a so-called 1T1C (1-Transistor and 1-Capacitor)-type pixel structure made up of one TFT and one capacitor.

The TFT 531 operates as a switch for selecting the pixel 530 and is formed of an N-type MOS (Metal Oxide Semiconductor), for example. The TFT 531 has a gate terminal connected to a scanning line, a source terminal connected to a data line, and a drain terminal connected to one terminal of the capacitor 532 and the pixel electrode 533. The other terminal of the capacitor 532 is connected to the common electrode 534. A power having a potential VCOM from the common electrode power source 60 is supplied to the other terminal of the capacitor 532 and the common electrode 534. The capacitance of the capacitor 532 has a magnitude capable of maintaining the potential which maintains the display image data for a predetermined period (for example, one frame period).

In the pixel 530, when the TFT 531 is turned ON by the drive signal input from the scanning line drive circuit 51 through the scanning line, the potential of the display image data input from the data line drive circuit 52 through the data line is charged to the capacitor 532. By the potential of the display image data charged to the capacitor 532, the pixel electrode 533 is maintained at a level of the potential corresponding to the display image data. Moreover, by the potential difference between the pixel electrode 533 and the common electrode 534, the white and black particles in the electrophoretic element 535 causes electrophoresis, whereby the side of the common electrode 534 appears white or black.

Moreover, in the pixel 530, since the capacitor 532 maintains the potential of the display image data, even when the TFT 531 is turned OFF in accordance with the drive signal input from the scanning line drive circuit 51 through the scanning lines, the level of the potential of the pixel electrode 533 can be maintained at the level of the potential corresponding to the display image data. In this way, even when the driving of the EPD module 50 is stopped, the pixel 530 can maintain the potential corresponding to the display image data.

The electrophoretic element 535 is formed of a plurality of microcapsules which include white electrophoretic particles (hereinafter referred to as “white particles”) and black electrophoretic particles (hereinafter referred to as “black particles”). In the following description, it is assumed that the black particles in the electrophoretic element 535 are charged to a positive (+) potential and the white particles to a negative (−) potential.

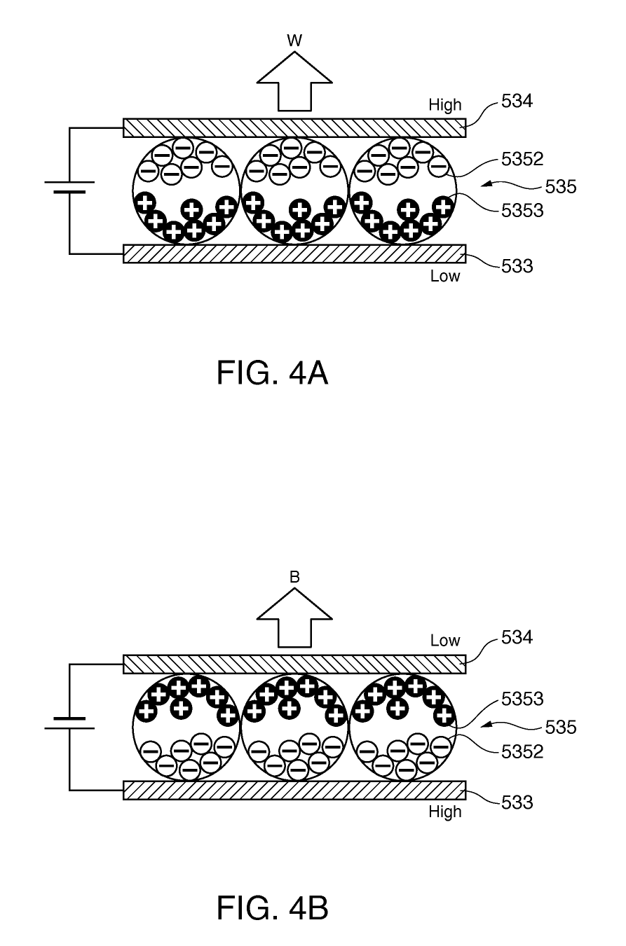

Next, an operation of electrophoretic particles in the electrophoretic element 535 will be described. FIGS. 4A and 4B are diagrams showing an example of an operation of the electrophoretic particles in the electrophoretic element 535 of the present embodiment. FIG. 4A shows a case where the pixel 530 represents white display, and FIG. 4B shows a case where the pixel 530 represents black display.

In the case of white display shown in FIG. 4A, the common electrode 534 is maintained at a relatively high potential, and the pixel electrode 533 is maintained at a relatively low potential. Therefore, negatively charged white particles 5352 are moved toward the common electrode 534, and positively charged black particles 5353 are moved toward the pixel electrode 533. As a result, when the pixel 530 is seen from the common electrode 534 side serving as a display surface side, white (W) is perceived. In the case of black display shown in FIG. 4B, the common electrode 534 is maintained at a relatively low potential, and the pixel electrode 533 is maintained at a relatively high potential. Therefore, positively charged black particles 5353 are moved toward the common electrode 534, and negatively charged white particles 5352 are moved toward the pixel electrode 533. As a result, when the pixel 530 is seen from the common electrode 534 side, black (B) is perceived. Moreover, when the potentials of the common electrode 534 and the pixel electrode 533 are the same (both at the low potential or the high potential), the white particles 5352 and the black particles 5353 in the electrophoretic element 535 do not cause electrophoresis but maintain the present display state.

Next, a method of driving the electro-optical device in the display device 1 of the present embodiment will be described. First, before describing the electro-optical device driving method, a configuration of the EPD module 50 provided in the display device 1 will be described. For the sake of description, it is assumed that the EPD module 50 has a configuration in which the pixels 530 are arranged two-dimensionally in 8 rows by 8 columns in the EPD 53 in the EPD module 50. Thus, the number of scanning lines in the row direction of the pixels 530 and the number of data lines in the column direction of the pixels 530 which are respectively output from the scanning line drive circuit 51 and the data line drive circuit 52 in the EPD module 50 are eight.

When an image is displayed on the EPD module 50, scanning lines on the row direction of the EPD 53 in the EPD module 50 are sequentially scanned one by one in the column direction from top to bottom, whereby an image is displayed. A period necessary for scanning one line of the EPD module 50 is one frame period or one vertical scanning period (hereinafter referred to as a “V period”), and a period necessary for writing image data to the pixels 530 through one scanning line is one scanning line period or one horizontal scanning period (hereinafter referred to as an “H period”). Therefore, in the EPD module 50 of the display device 1 of the present embodiment, the period necessary for displaying an image on the EPD module 50 also satisfies Equation (1) above.

The EPD controller 30 that controls the EPD module 50 having such a configuration determines that the EPD module 50 is in an entire screen drive mode when the information of the display starting line and the display ending line included in the display position control signal input from the CPU 20 indicates that the display starting line is 1 and the display ending line is 8. In this case, the EPD controller 30 controls the EPD module 50 so that the potential of the display image data is written to all pixels 530 of the EPD 53 in the EPD module 50. Moreover, the EPD controller 30 determines that the EPD module 50 is in a partial drive mode when the information of the display starting line and the display ending line indicates that the display starting line is not 1 or the display ending line is not 8. In this case, the EPD controller 30 controls the EPD module 50 so that the potential of the display image data is written to only a part of the pixels 530 of the EPD 53 in the EPD module 50.

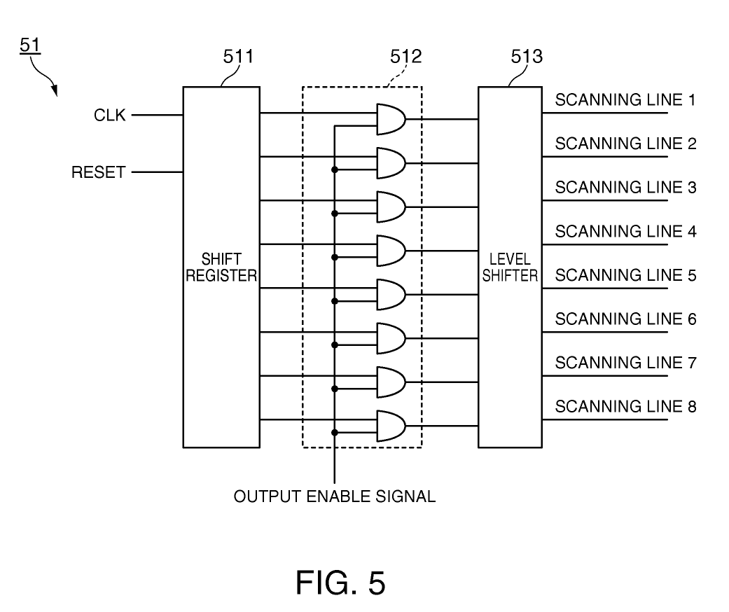

Next, a configuration of the scanning line drive circuit 51 in the EPD module 50 controlled by the EPD controller 30 will be described. FIG. 5 is a block diagram showing an example of a configuration of the scanning line drive circuit 51 in the EPD module 50 provided in the display device 1 of the present embodiment. In FIG. 5, the scanning line drive circuit 51 includes a shift register 511, an output select circuit 512, and a level shifter 513. A clock signal (CLK), a reset signal (RESET), and an output enable signal are input from the EPD controller 30 to the scanning line drive circuit 51 as a drive control signal. The scanning line drive circuit 51 outputs a drive signal for writing the potential of the data lines of the respective pixel columns of the EPD 53 to the scanning lines 1 to 8 corresponding to the respective pixel rows of the EPD 53.

The reset signal is a signal that resets the shift register 511. When the reset signal rises, all outputs of the shift register 511 are reset to a low level. The period of the reset signal corresponds to the frame period (V period). Moreover, the input timing of the reset signal corresponds to the start timing of the frame period. The clock signal is a clock for sequentially shifting the data in the shift register 511. The period of the clock signal corresponds to the scanning line period (H period). The output enable signal is a signal for controlling the output of the drive signal that is output to the scanning lines 1 to 8. The shift register 511 is an 8-stage shift register, and the drive signal output to the scanning lines 1 to 8 is sequentially changed to a high level in accordance with the output of the shift register 511. The output select circuit 512 selects the output of the level shifter 513 in accordance with the output enable signal. The level shifter 513 increases the output of the shift register 511 input through the output select circuit 512 to a voltage level sufficient for driving the TFTs 531 provided in the respective pixels 530 in the EPD 53 to an ON state.

When the drive start command is input from the CPU 20, the EPD controller 30 inputs the reset signal to the scanning line drive circuit 51 so as to reset the shift register 511. Moreover, the EPD controller 30 inputs a clock signal based on the display position control signal input from the CPU 20 to the shift register 511. The shift register 511 sequentially changes the outputs of the bits which are used for outputting the drive signal to the scanning lines to a high level in accordance with the clock signal input after the reset. The outputs of the bits which are not used for outputting the drive signal to the scanning lines are in the low level. The outputs of the respective bits of the shift register 511 are output to the output select circuit 512.

The EPD controller 30 inputs an output enable signal that represents a period for outputting the drive signal to the scanning lines to the scanning line drive circuit 51 based on the display position control signal input from the CPU 20. When the output enable signal is in the high level, the output select circuit 512 outputs the outputs of the shift register 511 to the level shifter 513. When the output enable signal is in the low level, the output select circuit 512 outputs a low level to the level shifter 513 regardless of the outputs of the shift register 511.

The level shifter 513 increases the high-level outputs of the shift register 511 input through the output select circuit 512 and outputs the increased high-level signals as the drive signal of the scanning lines. The TFTs 531 provided in the respective pixels 530 in the EPD 53 are turned ON by the high level of the drive signal. In this way, the potential of the display image data is written to the respective pixels 530.

Moreover, the drive signal of the scanning lines is fixed to the low level by the low-level outputs of the shift register 511 input to the level shifter 513 through the output select circuit 512. In this way, the TFTs 531 provided in the respective pixels 530 in the EPD 53 are turned OFF, the potential of the display image data is not written to the respective pixels 530, and the respective pixels 530 in the EPD 53 maintain the previously written display state.

Therefore, the EPD controller 30 controls the EPD module 50 so as to decrease the period of the clock signal in a period in which writing of data into the pixels 530 in the EPD 53 is not performed in accordance with the display position control signal input from the CPU 20, namely a period in which the output enable signal is in the low level. That is, among the scanning lines 1 to 8, a scanning line of the pixel row in which the potential of the display image data is not written to the pixels 530 in the EPD 53 is fast-forwarded or skipped. In this way, the H period in which the potential of the display image data is not written to the pixels 530 in the EPD 53 can be shortened, and the V period in which the display image data are displayed on the EPD module 50 can be shortened. As a result, it is possible to improve the update frequency of the image data displayed in the display device 1.

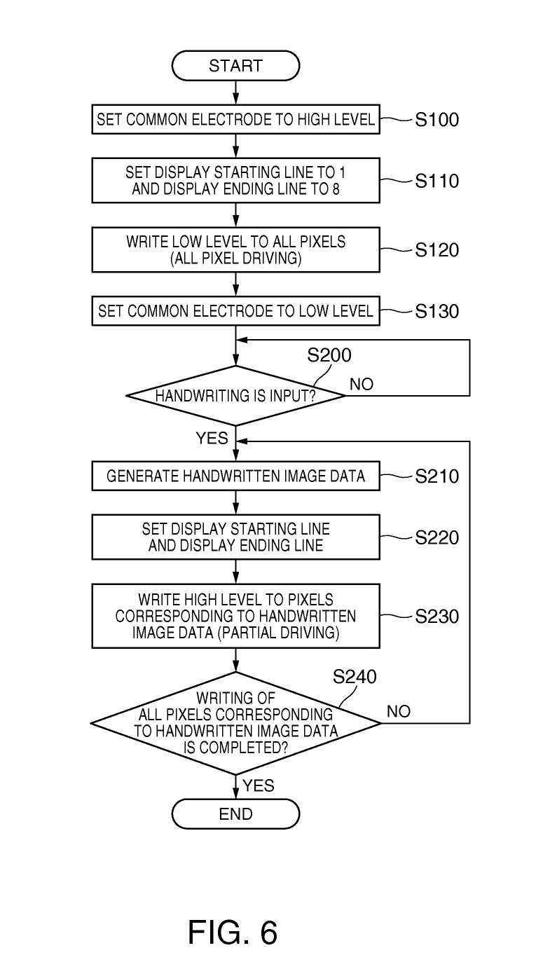

Next, a method of driving the EPD module 50 in the display device 1 will be described. FIG. 6 is a flowchart showing a method of driving the EPD module 50 provided in the display device 1 of the present embodiment. The flowchart shown in FIG. 6 shows a case in which the display of the EPD module 50 is first removed, and then, the user of the display device 1 inputs a handwritten line using the pointing device 70.

First, in step S100, the CPU 20 outputs a drive start command for resetting (all white removal) the display of the entire screen of the EPD module 50 to a white display state to the EPD controller 30. The EPD controller 30 sets the potential VCOM of the common electrode of the EPD 53 to the high level based on the drive start command input from the CPU 20 and outputs a common electrode control signal for creating a state in which white data can be written to all pixels 530 of the EPD 53 to the common electrode power source 60. In this way, the common electrode power source 60 puts the changeover switch 61 into an ON state and the changeover switch 62 into an OFF state, and the potential VCOM of the power supplied to the common electrode of the EPD 53 is changed to the high level (+15 V).

Subsequently, in step S110, the CPU 20 outputs a display position control signal indicating that the display starting line is 1 and the display ending line is 8 to the EPD controller 30 so that the EPD module 50 is driven in the entire screen drive mode. In this way, the EPD controller 30 determines that the present writing operation on the EPD module 50 is performed in the entire screen drive mode.

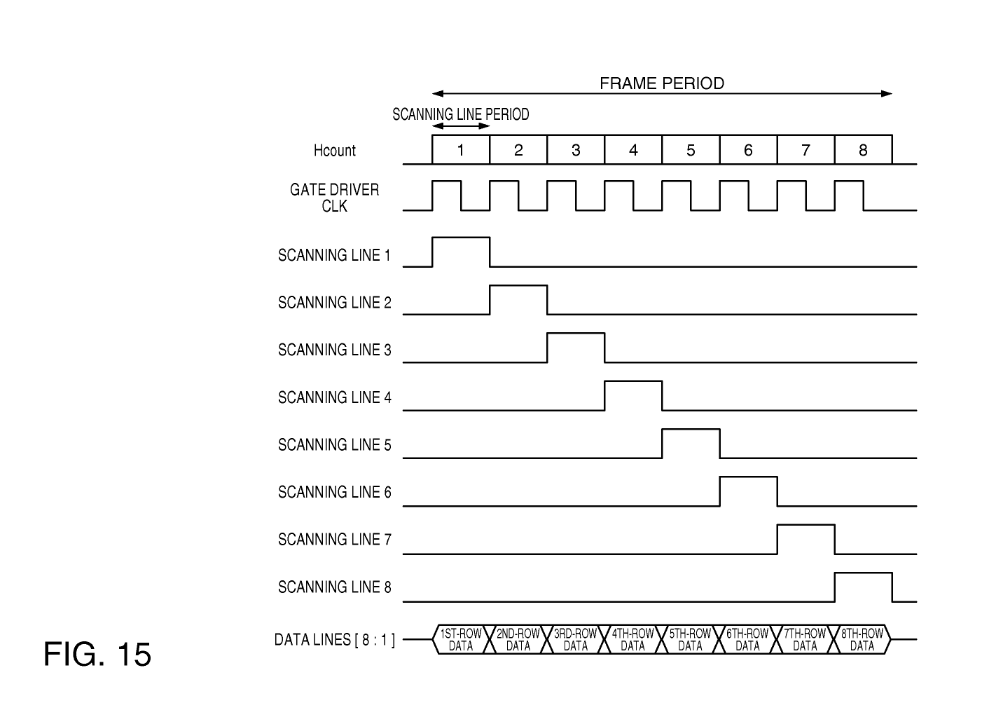

Subsequently, in step S120, the EPD controller 30 controls the EPD module 50 so that a low level is written to all pixels 530 of the EPD 53 in the entire screen drive mode. Through this control, the drive signal is sequentially output from the scanning line drive circuit 51 in the EPD module 50 to the scanning lines 1 to 8. In this way, the respective pixel rows in the EPD 53 are sequentially scanned, and the TFTs 531 provided in the respective pixels 530 on the scanned pixel rows in the EPD 53 are turned ON, whereby a low level is written to the respective pixels 530 and the potential of the low level (0 V) is applied to the pixel electrodes 533. As a result, the white particles 5352 of the electrophoretic elements 535 in the respective pixels 530 are moved toward the common electrode 534 by electrophoresis, and a white display state is created on the entire screen of the EPD module 50. The drive timing scheme at this moment is the same as the drive timing scheme of the electro-optical device provided in the display device of the related art shown in FIG. 15.

When the writing of data into the respective pixels 530 in the EPD 53 is performed for a plurality of frames, namely a plurality of V periods, the writing operation on the EPD module 50 in the entire screen drive mode in step S120 is repeated for the necessary number of frames. For example, when the respective pixels 530 in the EPD 53 are scanned two times (two frames) so as to write data into the respective pixels 530 in the EPD 53, the writing operation on the EPD module 50 is repeated for two frames (2V periods).

Here, the drive timing scheme of the EPD module 50 in the entire screen drive mode will be described with reference to FIG. 15. In the EPD 53, it is assumed that the pixels 530 having the 1T1C structure shown in FIG. 3 are two-dimensionally arranged in 8 rows by 8 columns, and writing of data into the respective pixels 530 in the EPD 53 is performed for 2V periods. Moreover, it is assumed that in the entire screen drive mode, the scanning line period (H period) is 10 ms, and the frame period (V period) is 80 ms. In the entire screen drive mode, since all pixel rows in the EPD 53 are sequentially scanned, the application period of the potential of the low level (0 V) applied to the electrophoretic elements 535 at the time of the all white removal is 2V periods (=160 ms).

In the all white removal, as shown in FIG. 15, the drive signal of the scanning lines 1 to 8 is sequentially changed to the high level, and the TFTs 531 provided in the respective pixels 530 on the respective pixel rows in the EPD 53 are sequentially turned ON every 10 ms. In this way, the low level is sequentially written to the capacitors 532, and the potential of the pixel electrodes 533 are changed to the low level. Moreover, for a period up to the next writing operation, namely a 1V period, the potential of the pixel electrodes 533 becomes the potential maintained in the capacitors 532. Since this writing operation is repeated for two frames, the potential of the pixel electrodes 533 becomes the potential maintained in the capacitors 532 for 2V periods. For the 2V periods, the white particles 5352 of the electrophoretic elements 535 of the respective pixels 530 are moved toward the common electrode 534 through electrophoresis, and a white display state is created on the EPD module 50. Therefore, in the entire screen drive mode, for 160 ms, the white particles 5352 of the electrophoretic elements 535 of the respective pixels 530 are moved toward the common electrode 534 through electrophoresis, and a white display state is created on the entire screen of the EPD module 50. In the following description, it is assumed that a response period necessary for the display of the entire screen of the EPD module 50 to transition from the black display state to the white display state, or from the white display state to the black display state is 160 ms.

Subsequently, when the reset (all white removal) of the entire screen of the EPD module 50 is completed, in step S130, the EPD controller 30 sets the potential VCOM of the common electrode of the EPD 53 to the low level and outputs a common electrode control signal for creating a state in which black data can be written to the respective pixels 530 in the EPD 53 to the common electrode power source 60. In this way, the common electrode power source 60 puts the changeover switch 61 into an OFF state and the changeover switch 62 into an ON state, and the potential VCOM of the voltage supplied to the common electrode of the EPD 53 is changed to the low level (0 V). In addition, the CPU 20 starts the operation of the position detection section 10 so as to create a state in which the user of the display device 1 can input handwriting.

Subsequently, in step S200, the CPU 20 determines whether or not the user of the display device 1 has input handwriting. When no handwriting is input, step S200 is repeated. When handwriting is input, the flow proceeds to step S210. Here, the handwriting is input when the user of the display device 1 traces on the EPD 53 in the EPD module 50 using the pointing device 70, and the position detection section 10 detects the coordinate on the EPD 53 and outputs the detected coordinate information to the CPU 20. The CPU 20 determines whether or not the user of the display device 1 has input handwriting based on whether or not the coordinate information is input from the position detection section 10.

Subsequently, when it is determined in step S200 that handwriting is input, the CPU 20 generates handwritten image data based on a plurality of pieces of coordinate information input from the position detection section 10 and stores the handwritten image data in the image memory 40 in step S210. The handwritten image data generated by the CPU 20 are the image data of the handwritten trajectory and are generated for each frame in which data are written into the respective pixels 530 of the EPD 53 in the EPD module 50. Therefore, if it is determined that the handwriting is input for the fist time, handwritten image data are generated for a frame (the first frame) in which data are written to the respective pixels 530 of the EPD 53 for the first time, and the generated handwritten image data are stored in the image memory 40.

Subsequently, in step S220, the CPU 20 outputs a display position control signal indicating the display starting line and the display ending line of the handwritten image data generated in the step S210 to the EPD controller 30 in order to drive the EPD module 50 in a partial drive mode. In this way, the EPD controller 30 determines that the present writing operation on the EPD module 50 is in the partial drive mode wherein a partial area of the range set by the display position control signal is driven.

Subsequently, in step S230, the EPD controller 30 controls the EPD module 50 so that a high level is written to the pixels 530 of the EPD 53 corresponding to the handwritten image data in the partial drive mode. Through this control, the drive signal is sequentially output from the scanning line drive circuit 51 in the EPD module 50 to the scanning lines 1 to 8 on the pixel rows corresponding to the handwritten image data. In this way, the respective pixel rows in the EPD 53 are partially scanned, and the TFTs 531 provided in the respective pixels 530 on the scanned pixel rows in the EPD 53 are turned ON, whereby a high level is written to the pixels 530 corresponding to the handwritten image data and the potential of the high level (+15 V) is applied to the pixel electrodes 533. As a result, the black particles 5353 of the electrophoretic elements 535 in the respective pixels 530 corresponding to the handwritten image data in the EPD 53 are moved toward the common electrode 534 by electrophoresis, and a black display state is created at the positions of the EPD module 50 corresponding to the handwritten image data.

In step S230, the writing operation based on the handwritten image data is not performed with respect to the pixels 530 of the EPD 53, which do not correspond to the handwritten image data. Therefore, in order to decrease the V period, the EPD controller 30 performs control so that the scanning lines on the pixel rows of the EPD 53, which do not correspond to the handwritten image data, are fast-forwarded or skipped. In this way, the scanning line drive circuit 51 of the EPD module 50 does not output the drive signal to the scanning lines 1 to 8 corresponding to the pixel rows in which the writing operation of the potential based on the display image data is not performed with respect to the pixels 530 in the EPD 53. The drive timing scheme at this moment will be described later.

Subsequently, in step S240, the CPU 20 determines whether or not the writing operation has been completed with respect to all the pixels 530 in the EPD 53 corresponding to the handwritten image data. When the writing operation has been completed with respect to all the pixels 530 in the EPD 53, the display of the handwritten input by the user of the display device 1 ends. When the writing operation has not been completed with respect to all the pixels 530 in the EPD 53, the flow returns to step S210, and an operation of generating the handwritten image data for the next frame in which data are written into the respective pixels 530 of the EPD 53 and an operation of writing data into the pixels 530 corresponding to the handwritten image data in the partial drive mode are repeated.

When the writing of data into the respective pixels 530 in the EPD 53 is performed for a plurality of frames, the operations of steps S210 to S240 are repeated for the necessary number of frames, whereby data are written into the respective pixels 530. For example, when the respective pixels 530 in the EPD 53 are scanned two times (two frames) so as to write data into the respective pixels 530 in the EPD 53, two handwritten image data are generated respectively for the first frame and the second frame, and the two handwritten image data are written to the EPD module 50 in the respective frames.

### First Drive Timing Scheme

Next, the drive timing scheme of the electro-optical device in the display device 1 of the present embodiment will be described. The first drive timing scheme shows a case in which the handwritten image data are written into the pixels 530 corresponding to the handwritten image data in the partial drive mode shown in step S230 of FIG. 6.

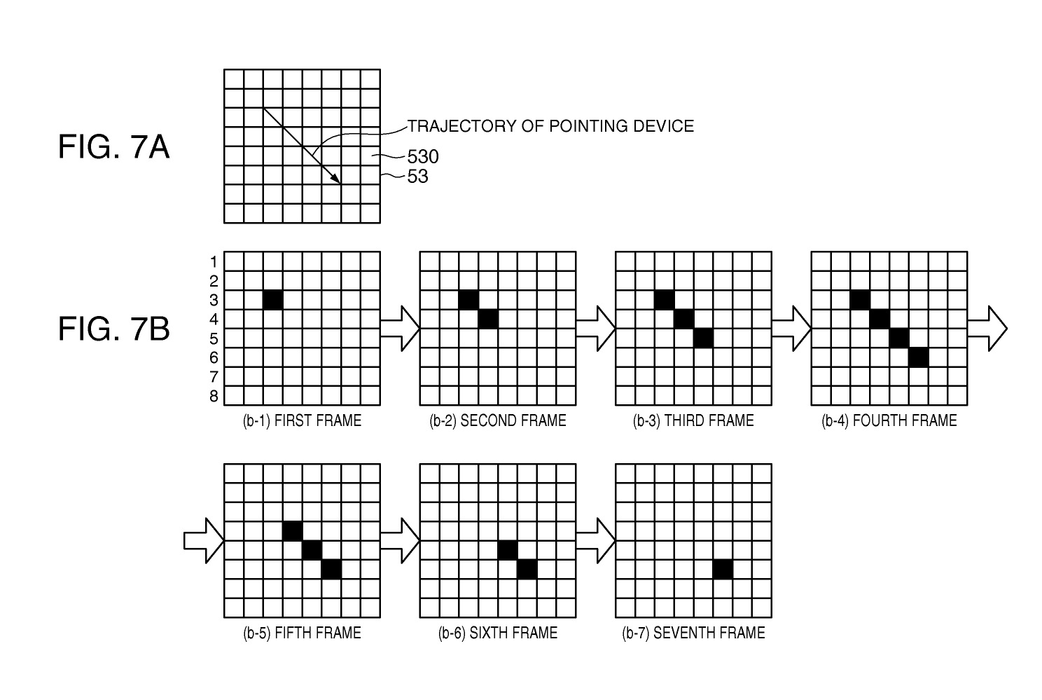

First, before the description of the first drive timing scheme, the handwritten image data generated by the CPU 20 will be described. FIGS. 7A and 7B are diagrams explicitly showing a writing trajectory handwritten on the EPD 53 in the EPD module 50 provided in the display device 1 of the present embodiment and the first handwritten image data. When the user of the display device 1 handwrites a trajectory of a straight line obliquely extending from top-left to bottom-right as shown in FIG. 7A for 160 ms using the pointing device 70, the CPU 20 generates handwritten image data of seven frames as shown in FIG. 7B. In the respective frames shown in FIG. 7B, the pixels 530 at positions where they are shown in black represent the positions of pixels 530 in which the potential of a high level corresponding to the display image data is applied to the pixel electrodes 533 so that the pixels 530 in the corresponding frame represent black display. Moreover, in the respective frames shown in FIG. 7B, the pixels 530 at positions where they are shown in white represent the positions of pixels 530 in which no potential is applied to the pixel electrodes 533, or the potential of the same low level as the common electrode 534 is applied to the pixel electrodes 533, whereby the black particles 5353 or the white particles 5352 in the electrophoretic elements 535 do not cause electrophoresis, so that the pixels 530 in the corresponding frame maintain the previously written display state. For example, the previously written display state represents a white display state when the previous writing operation has created an all white removal state and represents a black display state when the previous writing operation has created black display corresponding to the handwritten image data.

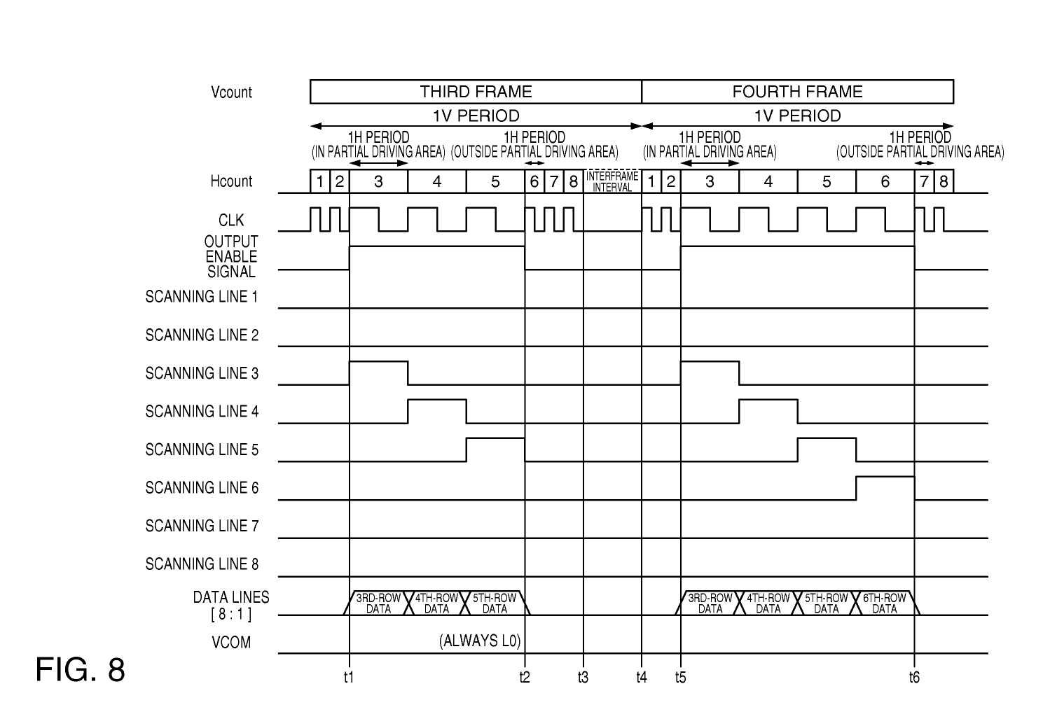

Next, the first drive timing scheme will be described. FIG. 8 is a timing chart showing an overview of the first drive timing scheme of the EPD module 50 provided in the display device 1 of the present embodiment. In the first drive timing scheme shown in FIG. 8, the 1V period is set to 40 ms, which is 80 ms in the entire screen drive mode, whereby the update frequency of the handwritten image data displayed in the display device 1 is improved. With the improvement in the update frequency of the handwritten image data, the writing operation on the respective pixels in the EPD 53 is performed for 4V periods. In this way, a period of 160 ms is secured as the application period of the potential of the high level (+15 V) applied to the electrophoretic elements 535. Therefore, the pixels 530 shown in black in FIG. 7B represent black display through the writing of handwritten image data of four frames.

The timing chart shown in FIG. 8 shows the drive timing scheme when displaying two handwritten image data of the third and fourth frames shown in b-3 and b-4 in FIG. 7B on the EPD 53 in the EPD module 50.

In the first drive timing scheme shown in FIG. 8, in order to shorten the V period using the partial drive mode, the writing of handwritten image data on the first and second pixel rows shown in b-3 and b-4 in FIG. 7B in which all pixels 530 represent white display is skipped. In the following description, an area in a period in which the writing of handwritten image data is skipped is referred to be “outside a partial driving area.” Conversely, an area in a period in which the writing of handwritten image data is not skipped, namely the writing of handwritten image data is performed is referred to be “in the partial driving area.” The EPD controller 30 increases (decreases the period of the clock signal) the frequency of the clock signal output to the scanning line drive circuit 51 with respect to pixel rows outside the partial driving area in which the writing on the pixels 530 is skipped.

More specifically, the EPD controller 30 outputs a clock signal having an increased frequency (hereinafter referred to as a “fast-forward clock signal”) to the scanning line drive circuit 51 in areas outside the partial driving area (the pixel rows of the EPD 53 shown in FIG. 7B, in which all pixels 530 are shown in white). Moreover, the EPD controller 30 outputs a clock signal having a frequency (hereinafter referred to as a “writing clock signal”) representing a period of 10 ms, in which the TFTs 531 in the pixels 530 are turned ON, to the scanning line drive circuit 51 in areas in the partial driving area (the pixel rows of the EPD 53 shown in FIG. 7B, which include a pixel 530 shown in black).

Moreover, in the areas outside the partial driving area, the EPD controller 30 sets the output enable signal to the low level so that the drive signal output from the scanning line drive circuit 51 to the scanning lines 1 to 8 is fixed to the low level. Moreover, in the areas in the partial driving area, the EPD controller 30 sets the output enable signal to the high level so that the drive signal output to the scanning lines 1 to 8 on the pixel rows in which the potential of the display image data is written to the pixels 530 in the EPD 53 is changed to the high level.

During the period in which the output enable signal is set to the low level in the areas outside the partial driving area, the EPD controller 30 makes the potential output from the data line drive circuit 52 to the data lines of the respective pixels 530 the same as the potential of the common electrode 534. The reason of this is as follows. For example, when the potential of the handwritten image data output in the previous frame or the previous pixel row remains on the data lines, the drive signal is fixed to the low level based on the low level of the output enable signal, and the TFTs 531 are in the OFF state. However, in this case, a potential different from the potential of the common electrode 534 may be applied to the pixel electrodes 533 due to the leaking current in the OFF state of the TFTs 531, whereby a potential difference is generated between the pixel electrode 533 and the common electrode 534. When there is a potential difference between the pixel electrode 533 and the common electrode 534, the black particles 5353 or the white particles 5352 in the electrophoretic elements 535 may cause electrophoresis, which makes the pixels unable to maintain their display state, whereby the display of the pixels 530 is degraded. Therefore, by setting the potential output from the data line drive circuit 52 to the data lines of the respective pixels 530 so as to be the same as the potential of the common electrode 534, it is possible to eliminate the potential difference between the pixel electrode 533 and the common electrode 534 and to prevent degradation of the display of the pixels 530.

In the first drive timing scheme shown in FIG. 8, in order to fix the 1V period to 40 ms, an interframe interval is inserted between the third and fourth frames so that the 1V period is fixed regardless of the number of scanning lines in the partial driving area.

More specifically, the EPD controller 30 stops the clock signal output to the scanning line drive circuit 51 during the interframe interval. Moreover, during the interframe interval, the EPD controller 30 sets the output enable signal to the low level so that the drive signal output from the scanning line drive circuit 51 to the scanning lines 1 to 8 is fixed to the low level.

Next, the first drive timing scheme will be described in more detail. As shown in FIG. 8, when the V period of the third frame starts, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the first and second rows in the EPD 53 is skipped (fast-forwarded). Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the first and second rows in the EPD 53 is maintained.

Subsequently, when an area in the partial driving area of the third frame is encountered at time t1, the EPD controller 30 outputs a writing clock signal to the scanning line drive circuit 51 and sets the output enable signal to the high level. In this way, the drive signal output to the scanning lines 3 to 5 is sequentially changed to the high level. Moreover, the EPD controller 30 outputs the handwritten image data of the third frame to the data line drive circuit 52. In this way, the TFTs 531 provided in the respective pixels 530 on the third to fifth rows in the EPD 53 are turned ON in accordance with the high level of the drive signal, and the handwritten image data of the third frame shown in b-3 in FIG. 7B are written to the corresponding pixels 530.

Subsequently, when an area outside the partial driving area is encountered at time t2, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the sixth to eighth rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the sixth to eighth rows in the EPD 53 is maintained.

Subsequently, when a period of inserting the interframe interval starts at time t3, the EPD controller 30 stops the clock signal output to the scanning line drive circuit 51. In this way, by the fast-forwarding, the EPD 53 stops the operation in a period in which the 1V period is shorter than 40 ms. During this interframe interval period, the potential of the data lines output from the data line drive circuit 52 is also fixed to the low level. In this way, it is possible to prevent degradation of the display of the pixels 530 resulting from the leaking current in the OFF state of the TFTs 531. More specifically, by setting the potential of the pixels 530 shown in white in FIG. 7B to the same low level as the common electrode 534, it is possible to prevent the occurrence of a potential difference between the pixel electrode 533 and the common electrode 534 and to prevent degradation of the display of the pixels 530.

Subsequently, when the V period of the fourth frame starts at time t4, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the first and second rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the first and second rows in the EPD 53 is maintained.

Subsequently, when an area in the partial driving area of the fourth frame is encountered at time t5, the EPD controller 30 outputs a writing clock signal to the scanning line drive circuit 51 and sets the output enable signal to the high level. In this way, the drive signal output to the scanning lines 3 to 6 is sequentially changed to the high level. Moreover, the EPD controller 30 outputs the handwritten image data of the fourth frame to the data line drive circuit 52. In this way, the TFTs 531 provided in the respective pixels 530 on the third to sixth rows in the EPD 53 are turned ON in accordance with the high level of the drive signal, and the handwritten image data of the fourth frame shown in b-4 in FIG. 7B are written to the corresponding pixels 530.

Subsequently, when an area outside the partial driving area is encountered at time t6, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the seventh and eighth rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the seventh and eighth rows in the EPD 53 is maintained.

After that, the writing of the handwritten image data of the fifth frame shown in b-5 in FIG. 7B into the pixels 530 is continued. In the writing of handwritten image data of the fourth frame into the pixels 530, since there is no period in which the 1V period is shorter than 40 ms by the fast-forwarding, the EPD controller 30 does not insert the interframe interval.

In the first drive timing scheme shown in FIG. 8, the period between time t1 and time t2 in the third frame and the period between time t5 and t6 in the fourth frame correspond to the first period in which the scanning lines connected to part of the pixels are selected and display image data are input to the part of the pixels through the data lines. Moreover, the period between the start of the third frame and time t1, the period between time t2 and time t3, the period between time t4 and time t5 in the fourth frame, and the period between time t6 and the end of the fourth frame correspond to the second period in which the scanning lines which are not connected to the part of the pixels are selected. Here, “the period in which the respective scanning lines are selected” means a period (1H period corresponding to the scanning line in the 1V period) which is allocated to a certain scanning line in one frame. Here, in the period in which the respective scanning lines are selected, whether or not a drive signal for putting the TFTs connected to the scanning lines into an ON state is applied to the scanning lines is out of the question.

Next, the interframe interval period inserted between the frames will be described. The frequency of the clock signal output from the EPD controller 30 to the scanning line drive circuit 51 can be increased to about several tens of MHz at which a general semiconductor integrated circuit operates. In this case, the period of the clock signal in the 1H period outside the partial driving area becomes 0.1 μs or smaller. Since this clock signal period is sufficiently shorter than the 1H period (10 ms) in the partial driving area, the period is sufficiently negligible with regard to the display of the EPD 53 in the EPD module 50. When the 1H period is increased, the 1H period in the partial driving area can be increased to an extent so as not to be negligible.

Here, assuming that the period of the clock signal in the 1H period outside the partial driving area is increased so that the 1H period outside the partial driving area is “0”, the V period (frame period) necessary for updating an image of one screen (one frame) displayed in the EPD 53 in the EPD module 50 of the display device 1 of the present embodiment is expressed by Equation (2) below based on the H period (scanning line period) in the partial driving area, the number of scanning lines (scanning line number) in the partial driving area, and the period of the interframe interval (interframe interval period).

V Period=(H Period)×(Scanning Line Number)+(Interframe Interval Period) (2)

Here, when the H period in the partial driving area is 10 ms, since the 1V period is fixed to 40 ms, the interframe interval period needs to be changed in accordance with the number of scanning lines in the partial driving area. The interframe interval period can be calculated as Equation (3) below from Equation (2) above.

$$\begin{matrix}Interframe Interval Period = ( V Period ) - ( H Period ) \times \\ ( Scanning Line Number ) \\ = ( 40 ms ) - ( 10 ms ) \times \\ ( Scanning Line Number )\end{matrix} \qquad ( 3 )$$

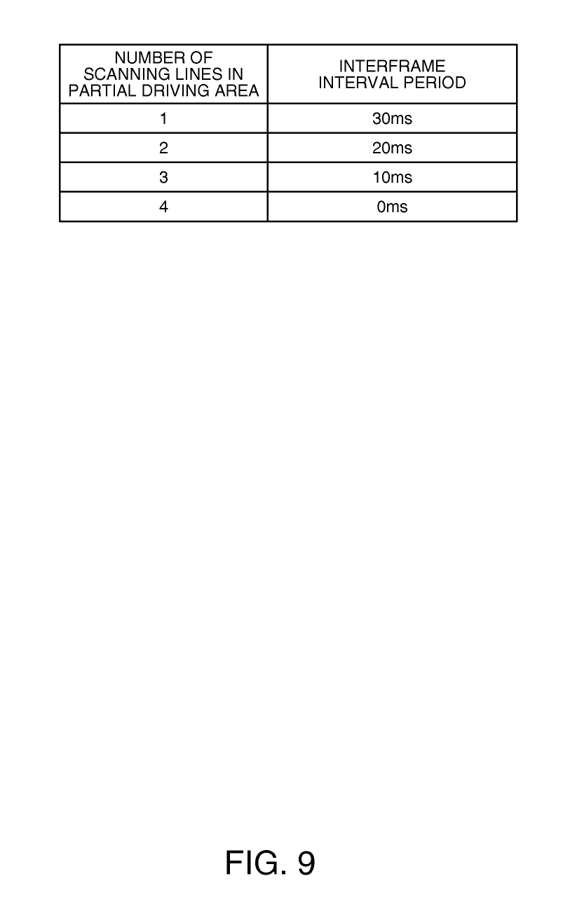

FIG. 9 shows a table in which the number of scanning lines in the partial driving area and the necessary interframe interval period are summarized based on Equation (3) above. Therefore, when controlling the EPD module 50 in accordance with the first drive timing scheme, the EPD controller 30 controls the EPD module 50 so that the interframe interval of the interframe interval period shown in FIG. 9 is inserted at the end of the respective frames.

As described above, according to the first drive timing scheme of the EPD module 50 in the display device 1 of the present embodiment, by shortening (fast-forwarding) the H period of the pixel rows in which the writing of data into the pixels 530 is skipped, the handwritten image data can be written to the pixels 530 in the partial driving area at an early time. In the first drive timing scheme, the V period in which the handwritten image data are displayed on the EPD 53 in the EPD module 50 can be decreased from 80 ms in the entire screen drive mode to 40 ms. In this way, it is possible to improve the update frequency of the handwritten image data displayed in the display device 1. As a result, when the pen-type pointing device was moved at the same speed, the number of updates of the image increases as compared to the case of updating the image by combining the trajectories of the pen-type pointing device in the display device of the related art. Thus, the trajectories can be displayed smoothly.

For example, when updating the image by combining the handwritten image data of the respective frames shown in b-1 to b-7 in FIG. 7B, in the display device of the related art, it is necessary to update the image by sequentially scanning all scanning lines 1 to 8 as shown in FIG. 15. Thus, it is always necessary to write the handwritten image data into all pixels. Therefore, as shown in b-1 to b-7 in FIG. 7B, even when only the pixels on the third to sixth pixel rows are updated from the present display state, the pixels on the other pixel rows also need to be driven. When the V period is 80 ms, for example, the handwritten input by the user of the display device is reflected in a period of (80 ms)×(7 frames)=560 ms. On the other hand, in the first drive timing scheme, since the 1V period is 40 ms, even when updating the display of the EPD 53 in the EPD module 50 in the same 7 frames, the handwritten input by the user of the display device 1 can be reflected in a period of (40 ms)×(7 frames)=280 ms.

In the first drive timing scheme shown in FIG. 8, the 1V period is fixed to 40 ms, and the application period of the high-level potential applied to the electrophoretic elements 535 is set to 160 ms (=4V periods). In this way, the number of pixel rows in which the pixels 530 can be updated to black display in one frame is limited to 4 rows. This is to suppress the occurrence of display unevenness in the respective pixels 530 in the EPD 53 when the application period of the high-level potential applied to the electrophoretic elements 535 is fixed to 160 ms. For example, when the application period of the high-level potential applied to the electrophoretic elements 535 is not fixed, unevenness in the display of the EPD 53 in the EPD module 50 may occur due to the difference in the reflectivity in the black display of the respective pixels 530. Moreover, when the application period of the high-level potential applied to the electrophoretic elements 535 is not definite, it is difficult to achieve a balance (DC balance) of the positive and negative voltages applied to the respective pixels 530 in the EPD 53, for example. Thus, it is difficult to secure reliability of the EPD module 50.

Moreover, since the magnitude of the storage capacitance of the capacitors 532 of the pixels 530 is constant, when the 1V period changes, the potential of the pixel electrodes 533 at the ending time of the 1V period also changes. That is, the average voltage (effective voltage) applied to the pixel electrodes 533 in the 1V period changes, and thus, display unevenness occurs or it is difficult to achieve a DC balance. Therefore, in the first drive timing scheme shown in FIG. 8, the 1V periods is fixed, and the number of frames in which the display is changed to white or black display. Specifically, in the first drive timing scheme, the 1V period is fixed to 40 ms, and the number of frames is fixed to 4 frames. As described above, by fixing the 1V period, it is possible to fix the effective voltage applied to the pixel electrodes 533 in the 1V period. Thus, it is possible to obviate a problem in that display unevenness occurs and a problem in that it is difficult to achieve a DC balance.

Therefore, in the first display device 1 of the present embodiment, as understood from FIG. 9, the number of scanning lines in the partial driving area in the EPD 53 cannot be increased to 5 or more. For example, when the user of the display device 1 inputs handwriting using the pointing device 70 while moving the pointing device 70 at a fast speed, the CPU 20 limits the number of pixel rows, in which the pixels 530 (the pixels 530 shown in black in FIG. 7B) controlled so as to represent black display as included in the handwritten image data are included, to 4 rows. In this way, it is possible to limit the number of scanning lines in the partial driving area to 4. In this case, the CPU 20 temporarily stores the coordinate information exceeding four scanning lines, input from the position detection section 10 and generates the handwritten image data so that writing of the handwritten image data is performed later, whereby five or more scanning lines in the partial driving area can be dealt with.

Conversely, in applications where the display unevenness and reliability are not important, the application period of the high-level potential applied to the electrophoretic elements 535 may not be fixed, and the V period may not be fixed. In this case, the number of scanning lines in the partial driving area in the EPD 53 can be increased to 5 or more. Moreover, by not fixing the application period of the high-level potential applied to the electrophoretic elements 535 strictly to 160 ms, it is possible to increase the degree of freedom in the display of the EPD 53 in the EPD module 50. For example, when the H period in the partial driving area is 10 ms, and the number of scanning lines in the partial driving area is 5 rows, the V period becomes 50 ms. In this case, by setting the number of frames necessary for writing handwritten image data into the pixels 530 corresponding to the handwritten image data to three frames, the application period of the high-level potential applied to the electrophoretic elements 535 is set to 150 ms. Thus, it is possible to achieve an application period approaching a target potential application period of 160 ms.

### Second Drive Timing Scheme

Next, another drive timing scheme of the electro-optical device in the display device 1 of the present embodiment will be described. The second drive timing scheme shows a case in which the handwritten image data are written into the pixels 530 corresponding to the handwritten image data in the partial drive mode shown in step S230 of FIG. 6. Moreover, the writing trajectory handwritten by the user of the display device 1 using the pointing device 70 and the handwritten image data generated by the CPU 20 are the same as the writing trajectory handwritten on the EPD 53 in the EPD module 50 provided in the display device 1 according to the present embodiment and the first handwritten image data shown in FIGS. 7A and 7B, and thus, description thereof will be omitted.

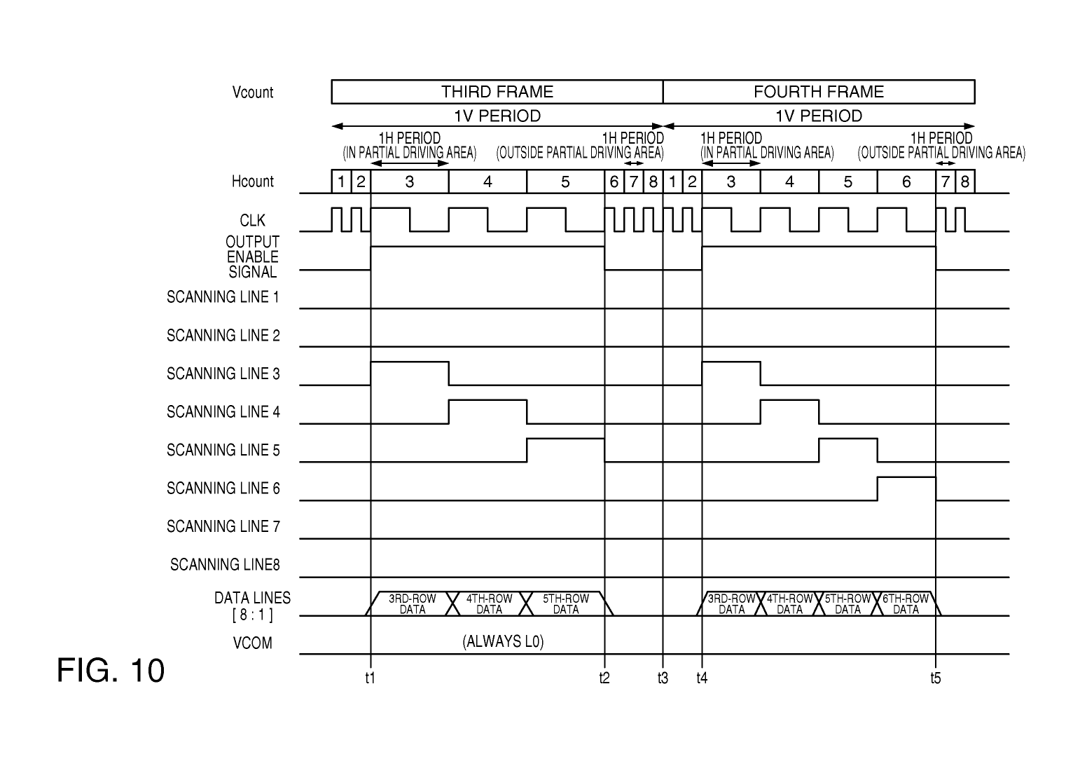

FIG. 10 is a timing chart showing an overview of the second drive timing scheme of the EPD module 50 provided in the display device 1 of the present embodiment. In the timing chart shown in FIG. 10, similarly to the first drive timing scheme shown in FIG. 8, the 1V period is set to 40 ms, which is 80 ms in the entire screen drive mode, whereby the update frequency of the handwritten image data displayed in the display device 1 is improved. Moreover, in the second drive timing scheme shown in FIG. 10, similarly to the first drive timing scheme shown in FIG. 8, the writing operation on the respective pixels in the EPD 53 is performed for 4V periods, whereby a period of 160 ms is secured as the application period of the potential of the high level (+15 V) applied to the electrophoretic elements 535.

Similarly to the first timing chart shown in FIG. 8, the timing chart shown in FIG. 10 shows the drive timing scheme when displaying two handwritten image data of the third and fourth frames shown in b-3 and b-4 in FIG. 7B on the EPD 53 in the EPD module 50.

The first drive timing scheme shown in FIG. 8 is different from the second drive timing scheme in that the frequency of the writing clock signal that the EPD controller 30 outputs to the scanning line drive circuit 51 is not fixed, but the frequency of the writing clock signal is changed in accordance with the number of pixel rows of the EPD 53 in which the handwritten image data are written in the partial driving area, namely the number of scanning lines to which the drive signal is output. However, even when the frequency of the writing clock signal is changed, the 1V period is fixed to 40 ms, and the update frequency of the handwritten image data displayed in the display device 1 is improved. Due to the different output control of the frequency of the writing clock signal, in the second drive timing scheme, since there is no period of inserting the interframe interval, the EPD controller 30 does not stop the clock signal output to the scanning line drive circuit 51.

Next, the second drive timing scheme will be described in more detail. As shown in FIG. 10, when the V period of the third frame starts, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the first and second rows in the EPD 53 is skipped (fast-forwarded). Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the first and second rows in the EPD 53 is maintained.

Subsequently, when an area in the partial driving area of the third frame is encountered at time t1, the EPD controller 30 outputs a writing clock signal having a frequency corresponding to the number of scanning lines in the partial driving area, to which the drive signal is output, to the scanning line drive circuit 51 and sets the output enable signal to the high level. In this way, the drive signal output to the scanning lines 3 to 5 is sequentially changed to the high level. Moreover, the EPD controller 30 outputs the handwritten image data of the third frame to the data line drive circuit 52. In this way, the TFTs 531 provided in the respective pixels 530 on the third to fifth rows in the EPD 53 are turned ON in accordance with the high level of the drive signal, and the handwritten image data of the third frame shown in b-3 in FIG. 7B are written to the corresponding pixels 530.

Subsequently, when an area outside the partial driving area is encountered at time t2, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the sixth to eighth rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the sixth to eighth rows in the EPD 53 is maintained.

Subsequently, when the V period of the fourth frame starts at time t3, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the first and second rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the first and second rows in the EPD 53 is maintained.

Subsequently, when an area in the partial driving area of the fourth frame is encountered at time t4, the EPD controller 30 outputs a writing clock signal having a frequency corresponding to the number of scanning lines in the partial driving area, to which the drive signal is output, to the scanning line drive circuit 51 and sets the output enable signal to the high level. In this way, the drive signal output to the scanning lines 3 to 6 is sequentially changed to the high level. Moreover, the EPD controller 30 outputs the handwritten image data of the fourth frame to the data line drive circuit 52. In this way, the TFTs 531 provided in the respective pixels 530 on the third to sixth rows in the EPD 53 are turned ON in accordance with the high level of the drive signal, and the handwritten image data of the fourth frame shown in b-4 in FIG. 7B are written to the corresponding pixels 530.

Subsequently, when an area outside the partial driving area is encountered at time t5, the EPD controller 30 outputs a fast-forward clock signal to the scanning line drive circuit 51 and sets the output enable signal to the low level. In this way, the drive signal output to the scanning lines 1 to 8 is fixed to the low level, and the writing of data into the pixels 530 on the seventh and eighth rows in the EPD 53 is fast-forwarded. Moreover, the EPD controller 30 sets the handwritten image data output to the data line drive circuit 52 during the fast-forward period to the low level. In this way, the potential of the data lines output from the data line drive circuit 52 is changed to the same low level as the potential of the common electrode 534, and the display of the pixels 530 on the seventh and eighth rows in the EPD 53 is maintained.

After that, the writing of the handwritten image data of the fifth frame shown in b-5 in FIG. 7B into the pixels 530 is continued.

In the second drive timing scheme shown in FIG. 10, the period between time t1 and time t2 in the third frame and the period between time t4 and t5 in the fourth frame correspond to the first period in which the scanning lines connected to part of the pixels are selected and display image data are input to the part of the pixels through the data lines. Moreover, the period between the start of the third frame and time t1, the period between time t2 and time t3, the period between time t3 and time t4 in the fourth frame, and the period between time t5 and the end of the fourth frame correspond to the second period in which the scanning lines which are not connected to the part of the pixels are selected.

Next, the frequency of the writing clock signal will be described. The frequency of the writing clock signal, namely the 1H period in the partial driving area is changed based on the number of scanning lines to which the drive signal is output. Moreover, similarly to the first drive timing scheme shown in FIG. 8, assuming that the period of the clock signal in the 1H period outside the partial driving area is increased so that the 1H period outside the partial driving area is “0”, the V period (frame period) necessary for updating an image of one screen (one frame) displayed in the EPD 53 in the EPD module 50 of the display device 1 of the present embodiment is expressed by Equation (4) below based on the H period (scanning line period) in the partial driving area and the number of scanning lines (scanning line number) in the partial driving area.

V Period=(H Period)×(Scanning Line Number) (4)

Here, in the second drive timing scheme, since the 1V period is fixed to 40 ms, the H period in the partial driving area is changed in accordance with the number of scanning lines in the partial driving area. The H period in the partial driving area can be calculated as Equation (5) below from Equation (4) above.

$$\begin{matrix}H Period = ( V Period ) / ( Scanning Line Number ) \\ = ( 40 ms ) / ( Scanning Line Number )\end{matrix} \qquad ( 5 )$$

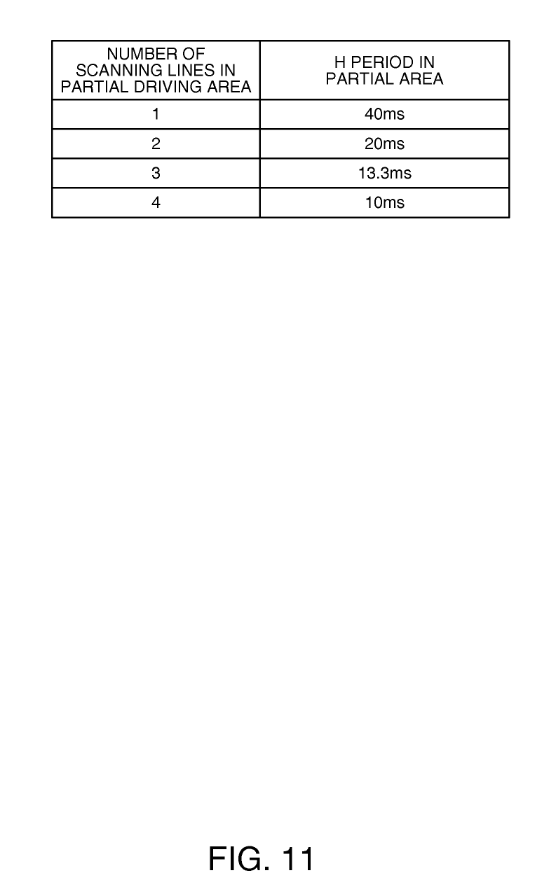

FIG. 11 shows a table in which the number of scanning lines in the partial driving area and the H period in the partial driving area are summarized based on Equation (5) above. Therefore, when controlling the EPD module 50 in accordance with the second drive timing scheme, the EPD controller 30 controls the scanning line drive circuit 51 and the data line drive circuit 52 in the EPD module 50 based on the information of the display starting line and the display ending line included in the display position control signal input from the CPU 20 so that the H period becomes the H period shown in FIG. 11.

More specifically, in the partial driving area, the EPD controller 30 controls the EPD module 50 in the following procedures. In this example, it is assumed that a period necessary for outputting the potential corresponding to the handwritten image data for one row in the 1H period from the data line drive circuit 52 to the data lines of all pixels 530 is 10 ms. Moreover, in the description of the following procedures, it is assumed that the data line drive circuit 52 has a storage area for storing the handwritten image data for two rows, and the EPD controller 30 sets (outputs) the handwritten image data of a pixel row subjected to the next writing operation to the data line drive circuit 52 in advance during the writing period of the pixels 530 on the previous row.

### Procedure 1

First, the data line drive circuit 52 outputs the potential corresponding to the handwritten image data which are set during the writing period for the previous row to the data lines of the respective pixels 530.

### Procedure 2

The EPD controller 30 sets the handwritten image data output from the data line drive circuit 52 in the next writing period to the data line drive circuit 52 in 10 ms.

### Procedure 3

Standby is performed for a period subtracted by the period (10 ms) necessary for controlling the data line drive circuit 52 from the 1H period shown in FIG. 11 (that is, a blanking period is inserted).

### Procedure 4

The EPD controller 30 inverts the clock signal input to the scanning line drive circuit 51 so that the drive signal output by the scanning line drive circuit 51 is output to the next scanning line.

As described above, according to the second drive timing scheme of the EPD module 50 in the display device 1 of the present embodiment, by shortening (fast-forwarding) the H period of the pixel rows in which the writing of data into the pixels 530 is skipped, the handwritten image data can be written to the pixels 530 in the partial driving area at an early time. In the second drive timing scheme, the V period in which the handwritten image data are displayed on the EPD 53 in the EPD module 50 can be fixed to 40 ms. In this way, it is possible to improve the update frequency of the handwritten image data displayed in the display device 1. As a result, when the pen-type pointing device was moved at the same speed, the number of updates of the image increases as compared to the case of updating the image by combining the trajectories of the pen-type pointing device in the display device of the related art. Thus, the trajectories can be displayed smoothly.

In the second drive timing scheme shown in FIG. 10, similarly to the first drive timing scheme shown in FIG. 8, the number of pixel rows in which the pixels 530 can be updated to black display in one frame is limited to 4 rows. However, similarly to the first drive timing scheme shown in FIG. 8, in applications where the display unevenness and reliability are not important, by not fixing the application period of the high-level potential applied to the electrophoretic elements 535, it is possible to increase the degree of freedom in the display of the EPD 53 in the EPD module 50.

Moreover, the EPD controller 30 may control the EPD module 50 in accordance with a drive timing scheme in which the first and second drive timing schemes shown in FIGS. 8 and 10 are combined. More specifically, for example, similarly to the first drive timing scheme shown in FIG. 8, in a frame in which the interframe interval is inserted, the H period in the partial driving area may be changed. In this case, the interframe interval being inserted may be determined based on the interframe interval period which is calculated considering the H period. For example, in FIG. 11, although the H period in the partial driving area is 13.3 ms when the number of scanning lines in the partial driving area is “3,” the H period may be set to 10 ms, and the remaining period may be used as the interframe interval period.

### Third Drive Timing Scheme

Next, a further drive timing scheme of the electro-optical device in the display device 1 of the present embodiment will be described. The third drive timing scheme shows a case in which the handwritten image data are written into the pixels 530 corresponding to the handwritten image data in the partial drive mode shown in step S230 of FIG. 6, and in which the fast-forwarding of areas outside the partial driving area is not performed, but the handwritten image data are written into the pixels 530 in the same V period as the drive timing scheme of the electro-optical device provided in the display device of the related art shown in FIG. 15.

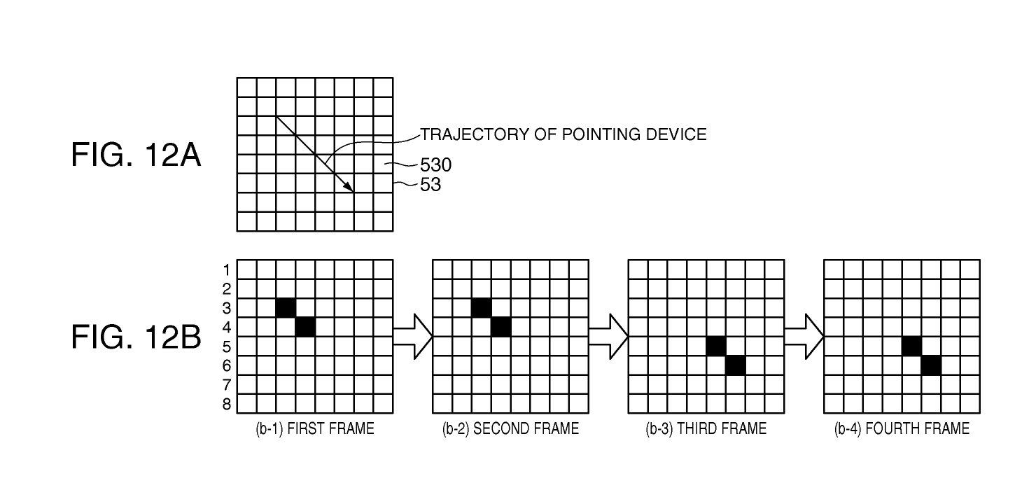

First, before the description of the third drive timing scheme, the handwritten image data generated by the CPU 20 will be described. FIGS. 12A and 12B are diagrams explicitly showing a writing trajectory handwritten on the EPD 53 in the EPD module 50 provided in the display device 1 of the present embodiment and the second handwritten image data. The writing trajectory of the handwritten input shown in FIG. 12A is the same as the writing trajectory of the handwritten input shown in FIG. 7A. FIG. 12B shows the frames of the second handwritten image data generated by the CPU 20 when the user of the display device 1 handwrites a trajectory of a straight line obliquely extending from top-left to bottom-right as shown in FIG. 12A for 160 ms using the pointing device 70. In the third drive timing scheme, since the update of the handwritten image data, namely the writing of data into the respective pixels in the EPD 53 is performed in the 2V periods similarly to the electro-optical device provided in the display device of the related art, the CPU 20 generates the handwritten image data of four frames as shown in FIG. 12B.

In the respective frames shown in FIG. 12B, similarly to the first handwritten image data shown in FIG. 7B, the pixels 530 at positions where they are shown in black represent the positions of pixels 530 in which the potential of a high level corresponding to the display image data is applied to the pixel electrodes 533 so that the pixels 530 in the corresponding frame represent black display. Moreover, in the respective frames shown in FIG. 12B, similarly to the first handwritten image data shown in FIG. 7B, the pixels 530 at positions where they are shown in white represent the positions of pixels 530 in which no potential is applied to the pixel electrodes 533, or the potential of the same low level as the common electrode 534 is applied to the pixel electrodes 533, whereby the black particles 5353 or the white particles 5352 in the electrophoretic elements 535 do not cause electrophoresis, so that the pixels 530 in the corresponding frame maintain the previously written display state. For example, similarly to the display state of the first handwritten image data shown in FIG. 7B, the previously written display state represents a white display state when the previous writing operation has created an all white removal state and represents a black display state when the previous writing operation has created black display corresponding to the handwritten image data.

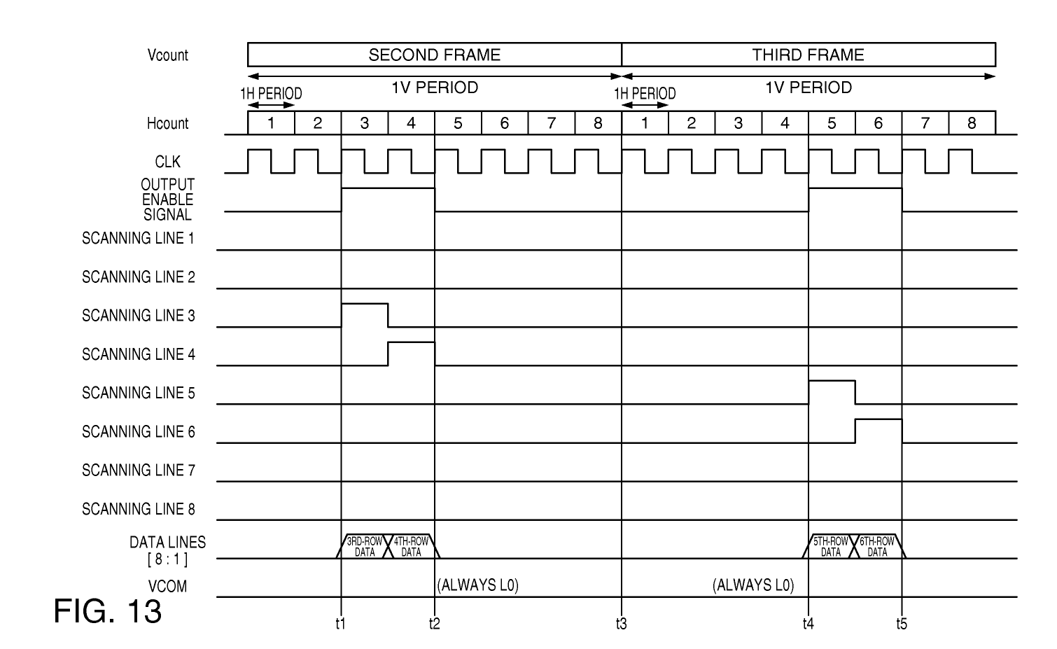

Next, the third drive timing scheme will be described. FIG. 13 is a timing chart showing an overview of the third drive timing scheme of the EPD module 50 provided in the display device 1 of the present embodiment. In the third drive timing scheme shown in FIG. 13, the 1V period is set to 80 ms which is the same as in the entire screen drive mode, whereby the update of the handwritten image data displayed in the display device 1 is made easy. In order to make the update of the handwritten image data easy, the writing operation on the respective pixels in the EPD 53 is performed for 2V periods. That is, the application period of the potential of the high level (+15 V) applied to the electrophoretic elements 535 is 160 ms which is the same as in the entire screen drive mode. Therefore, the pixels 530 shown in black in FIG. 12B represent black display through the writing of handwritten image data of two frames.

The timing chart shown in FIG. 13 shows the drive timing scheme when displaying two handwritten image data of the second and third frames shown in b-2 and b-3 in FIG. 12B on the EPD 53 in the EPD module 50. In the third drive timing scheme shown in FIG. 13, the handwritten image data are written into only the black pixels 530 shown in b-2 and b-3 in FIG. 12B.

In the following description, an area in which the handwritten image data are not written will be referred to as a “non-writing area.” On the other hand, an area in which the handwritten image data are written will be referred to as a “writing area.” The frequency of the clock signal output from the EPD controller 30 to the scanning line drive circuit 51 in the non-writing area and the writing area is the same as the frequency of the clock signal in the entire screen drive mode. Therefore, the V period is not decreased unlike the first and second drive timing schemes shown in FIGS. 8 and 10. However, according to the third drive timing scheme shown in FIG. 13, since the drive signal is output to only the scanning lines on the pixel rows in which the handwritten image data are written, it is possible to decrease the power consumption of the display device 1 itself as compared to the entire screen drive mode.

More specifically, in the non-writing areas, the EPD controller 30 sets the output enable signal to the low level so that the drive signal output from the scanning line drive circuit 51 to the scanning lines 1 to 8 is fixed to the low level. Moreover, in the writing areas, the EPD controller 30 sets the output enable signal to the high level so that the drive signal output to the scanning lines 1 to 8 on the pixel rows in which the potential of the display image data is written to the pixels 530 in the EPD 53 is changed to the high level.

During the period in which the output enable signal is set to the low level in the non-writing areas, the EPD controller 30 makes the potential output from the data line drive circuit 52 to the data lines of the respective pixels 530 the same as the potential of the common electrode 534. This is to prevent degradation of the display of the pixels 530 by eliminating the potential difference between the pixel electrode 533 and the common electrode 534 in the pixels 530 similarly to the first and second drive timing schemes shown in FIGS. 8 and 10.

Next, the third drive timing scheme will be described in more detail. As shown in FIG. 13, when the V period of the second frame starts, the EPD controller 30 sets the output enable signal to the low level. In this way, the drive signal output to the scanning lines 1 to 8 is fixed to the low level, and the writing of data into the pixels 530 on the first and second rows in the EPD 53 is not performed. Moreover, the EPD controller 30 sets the handwritten image data output to the data line drive circuit 52 during the period of the non-writing areas to the low level. In this way, the potential of the data lines output from the data line drive circuit 52 is changed to the same low level as the potential of the common electrode 534, and the display of the pixels 530 on the first and second rows in the EPD 53 is maintained.

Subsequently, when a writing area of the second frame is encountered at time t1, the EPD controller 30 sets the output enable signal to the high level. In this way, the drive signal output to the scanning lines 3 and 4 is sequentially changed to the high level. Moreover, the EPD controller 30 outputs the handwritten image data of the second frame to the data line drive circuit 52. In this way, the TFTs 531 provided in the respective pixels 530 on the third and fourth rows in the EPD 53 are turned ON in accordance with the high level of the drive signal, and the handwritten image data of the second frame shown in b-2 in FIG. 12B are written to the corresponding pixels 530.

Subsequently, when a non-writing area is encountered at time t2, the EPD controller 30 sets the output enable signal to the low level. In this way, the drive signal output to the scanning lines 1 to 8 is fixed to the low level, and the writing of data into the pixels 530 on the fifth to eighth rows in the EPD 53 is not performed. Moreover, the EPD controller 30 sets the handwritten image data output to the data line drive circuit 52 during the period of the non-writing areas to the low level. In this way, the potential of the data lines output from the data line drive circuit 52 is changed to the same low level as the potential of the common electrode 534, and the display of the pixels 530 on the fifth to eighth rows in the EPD 53 is maintained.

Subsequently, when the V period of the third frame starts at time t3, the EPD controller 30 sets the output enable signal to the low level. In this way, the drive signal output to the scanning lines 1 to 8 is fixed to the low level, and the writing of data into the pixels 530 on the first to fourth rows in the EPD 53 is not performed. Moreover, the EPD controller 30 sets the handwritten image data output to the data line drive circuit 52 during the period of the non-writing areas to the low level. In this way, the potential of the data lines output from the data line drive circuit 52 is changed to the same low level as the potential of the common electrode 534, and the display of the pixels 530 on the first to fourth rows in the EPD 53 is maintained.

Subsequently, when a writing area of the third frame is encountered at time t4, the EPD controller 30 sets the output enable signal to the high level. In this way, the drive signal output to the scanning lines 5 and 6 is sequentially changed to the high level. Moreover, the EPD controller 30 outputs the handwritten image data of the third frame to the data line drive circuit 52. In this way, the TFTs 531 provided in the respective pixels 530 on the fifth and sixth rows in the EPD 53 are turned ON in accordance with the high level of the drive signal, and the handwritten image data of the third frame shown in b-3 in FIG. 12B are written to the corresponding pixels 530.

Subsequently, when a non-writing area is encountered at time t5, the EPD controller 30 sets the output enable signal to the low level. In this way, the drive signal output to the scanning lines 1 to 8 is fixed to the low level, and the writing of data into the pixels 530 on the seventh and eighth rows in the EPD 53 is not performed. Moreover, the EPD controller 30 sets the handwritten image data output to the data line drive circuit 52 during the period of the non-writing areas to the low level. In this way, the potential of the data lines output from the data line drive circuit 52 is changed to the same low level as the potential of the common electrode 534, and the display of the pixels 530 on the seventh and eighth rows in the EPD 53 is maintained.

After that, the writing of the handwritten image data of the fourth frame shown in b-4 in FIG. 12 into the pixels 530 is continued.

As described above, according to the third drive timing scheme of the EPD module 50 in the display device 1 of the present embodiment, by writing the handwritten image data into only the pixel rows in which the handwritten image data are updated, it is possible to simplify the control in the partial drive mode. In this way, although it is not possible to improve the update frequency of the handwritten image data displayed in the display device 1, it is possible to decrease the power consumption of the display device 1.

As described above, in the display device 1 of the present embodiment, when handwriting is input by the user of the display device 1, only the range of areas of the EPD module 50 in which the user inputs handwriting can be refreshed by the partial drive mode rather than refreshing the entire screen of the EPD module 50.

In the display device 1 of the present embodiment, even when it is not possible to shorten the period (H period) in which data are written to the pixels of the EPD 53, by controlling the EPD module 50 in the partial drive mode, it is possible to shorten the V period by decreasing the writing period outside the range in which handwriting is input. As a result, it is possible to improve the frame rate when refreshing the display of the pixels so as to correspond to the handwritten image data and to improve the image update frequency. Moreover, by improving the image update frequency, the trajectory of the pen-type pointing device can be displayed smoothly as compared to the trajectory of the pen-type pointing device in the display device of the related art when the pen-type pointing device is moved at the same speed. For example, in the display device of the related art, since the frames of a handwritten image as shown in FIG. 12B are sequentially displayed, a change in the image representing the trajectory of the pen-type pointing device is large. However, in the display device 1 of the present embodiment, since the frames of a handwritten image as shown in FIG. 7B are sequentially displayed, a change in the image representing the trajectory of the pen-type pointing device is small. Thus, the trajectory of the pen-type pointing device can be displayed smoothly. More specifically, in the display device of the related art, a change in the image representing the trajectory of the pen-type pointing device is two pixels as shown in the second and third frames shown in b-2 and b-3 in FIG. 12. In contrast, in the display device 1 of the present embodiment, a change in the image representing the trajectory of the pen-type pointing device in all frames in FIG. 7B is one pixel.

### Electronic Apparatus

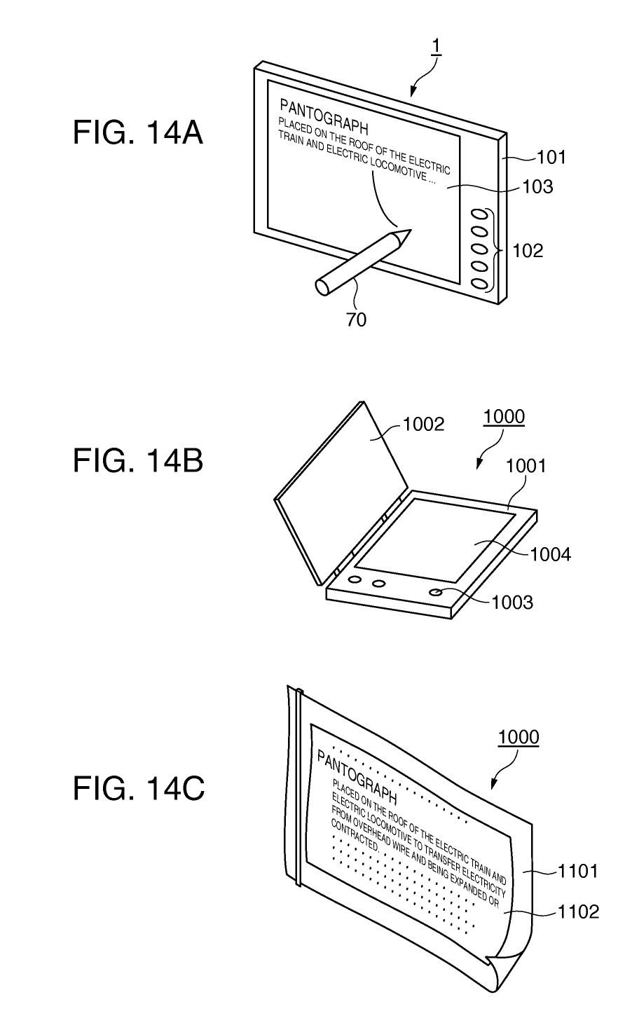

Next, an electronic apparatus according to the present embodiment will be described. FIGS. 14A to 14C are perspective views illustrating an example of an electronic apparatus in which the electro-optical device of the present embodiment is applied.

FIG. 14A is a perspective view showing the display device 1 which is an example of the electronic apparatus. The display device 1 includes a frame 101, an operation section 102, and a display section 103 which is controlled by an electro-optical device driving method and a drive controller according to the invention. The display section 103 enables the user to recognize the image data being displayed on the EPD 53 in the EPD module 50.

FIG. 14B is a perspective view showing an electronic book which is an example of the electronic apparatus. The electronic book 1000 includes a book-shaped frame 1001, a cover 1002 provided so as to be pivotable (openable and closable) relative to the frame 1001, an operation section 1003, and a display section 1004 which is controlled by an electro-optical device driving method and a drive controller according to the invention.

FIG. 14C is a perspective view showing a configuration of an electronic paper 1100. The electronic paper 1100 has flexibility and includes a main body 1101 formed of a rewritable sheet having the same texture and softness as the existing paper and a display section 1102 which is controlled by an electro-optical device driving method and a drive controller according to the invention. The electronic paper 1100 enables the user to draws an underline with the same feeling as in a printed material such as paper.

Since the display device 1, the electronic book 1000, and the electronic paper 1100 use the electro-optical device driving method and the drive controller according to the invention, it is possible to refresh only a region of areas in which the user inputs handwriting.

As described above, according to the embodiments of the invention, when the user inputs handwriting, only the region of areas in which the handwriting is input can be refreshed rather than refreshing the entire screen of the display section.

According to the embodiments of the invention, it is possible to improve the update frequency when the displayed contents being displayed on the display section are updated in accordance with the handwritten input. In this way, the display can be updated smoothly as compared to the electronic apparatus of the related art.

According to the embodiments of the invention, when the displayed contents being displayed on the display section are updated in accordance with the handwritten input, if the update frequency is set to be the same as the electronic apparatus of the related art, it is possible to decrease the power consumption of the electronic apparatus.

In the present embodiment, although a case of driving one continuous partial driving area has been described, the electro-optical device driving method, the drive controller, and the electronic apparatus according to the invention are not limited to the embodiment of the invention. A plurality of partial driving areas may be set, and the writing of data into the pixel rows outside the plurality of partial driving areas may be fast-forwarded.

When there is a large number of scanning lines outside the partial driving area to an extent that the fast-forward period cannot be negligible, or it is not possible to sufficiently increase the frequency of the clock signal input to the scanning line drive circuit, the period necessary for outputting the drive signal to the scanning lines in the partial driving area, namely the period up to the start of the update of the display of the display section may be increased. In this case, by configuring the scanning line drive circuit with a decoder-type scanning line drive circuit which is capable of making the standby period until the drive signal is output to the scanning lines substantially “0” by inputting an arbitrary display starting line and an arbitrary display ending line, it is possible to output the drive signal to the scanning lines in the partial driving area at an early time. With this configuration, it is possible to improve the update frequency of the contents being displayed on the display section in accordance with the handwritten input.

In the present embodiment, although a case in which the white particles 5352 are charged to the negative (minus: −) potential and the black particles 5353 are charged to the positive (plus: +) potential has been described, the invention is not limited to the embodiment. The same idea as the present embodiment can be applied to a case in which the white particles 5352 and the black particles 5353 have the reverse polarities, namely the white particles 5352 are charged to the positive (plus: +) potential and the black particles 5353 are charged to the negative (minus: −) potential.

In the present embodiment, although the case of the EPD module 50 capable of displaying a so-called black and white display gradation which displays two states of a white display state and a black display state has been described, the invention is not limited to the embodiment. The electro-optical device driving method and the drive controller according to the invention can be applied to an EPD module capable of displaying an intermediate gradation.

In the present embodiment, although the active-matrix EPD module 50 having the scanning line drive circuit 51 and the data line drive circuit 52 has been described, the invention is not limited to the embodiment. The EPD module 50 may be a passive-matrix or a segment driving electrophoretic display device. Moreover, another active matrix type may be employed. For example, a 2T1C (2-transistor and 1-capacitor) type in which each pixel includes a select transistor, a drive transistor, and a storage capacitor, and the drain of the select transistor and one electrode of the storage capacitor are connected to the gate of the drive transistor. Alternatively, an SRAM type in which each pixel includes a latch circuit connected to the drain of a select transistor may be employed, and a type in which the connection between a pixel electrode and a control line is controlled by the output of a latch circuit may be employed. In any of the types, when the select transistor is selected by the scanning line, an image signal from the data lines is supplied to the pixel circuit through the select transistor, and the pixel electrode has a potential corresponding to the image signal.

In any of the types, a part of the pixels 530 of the EPD 53 in the EPD module 50 can be selectively driven, and an image can be displayed using the electro-optical device driving method of the invention.

In the present embodiment, although a case in which the pixels are two-dimensionally arranged in 8 rows by 8 columns has been described as an example of the arrangement of the pixels in the directions of rows and columns, the pixel arrangement in the directions of rows and columns is not limited to the present embodiment. The number of pixels in the directions of rows and columns can be changed without departing from the spirit of the invention.

In the present embodiment, a case in which the position detection section 10 is provided in the display device 1, and the handwritten image data are generated based on the trajectory of handwriting which the user of the display device 1 inputs using the pointing device 70 and written into the pixels 530 corresponding to the generated handwritten image data has been described. However, the electro-optical device driving method, the drive controller, and the electronic apparatus of the invention are not limited to the present embodiment, but can be applied to an electro-optical device in which data are written to only a part of the pixels 530 of the EPD module 50 by the partial drive mode. For example, even when a popup menu is displayed in response to selecting of a part of an image being presently displayed, the image data of the popup menu may be treated similar to the handwritten image data of the present embodiment, and data may be written to only the pixels 530 corresponding to the image data of the popup menu.

In the present embodiment, although the case of the EPD that displays images through electrophoresis has been described, the electro-optical device driving method, the drive controller, and the electronic apparatus of the invention may be applied to an LCD (Liquid Crystal Display). When the driving method and the drive controller of the invention are applied to an LCD, so-called flicker wherein the display of the LCD blinks may occur. For example, by setting the H period and the interframe interval period so that no flicker occurs by a drive timing scheme in which the first and second drive timing schemes shown in FIGS. 8 and 10 are combined, it is possible to reflect the handwritten input by the user at an early time. Moreover, the power consumption of the LCD can be decreased.

Although the exemplary embodiments of the invention have been described with reference to the accompanying drawings, it should be understood that the invention is not limited to such embodiments but various changes may be made without departing from the spirit or scope of the invention.

The entire disclosure of Japanese Patent Application No. 2010-100134, filed Apr. 23, 2010 is expressly incorporated by reference herein.

What is claimed is:

1. A method of driving an electro-optical device, the electro-optical device including:
a plurality of scanning lines;
a plurality of data lines intersecting the plurality of scanning lines; and
a plurality of pixels arranged at positions corresponding to the intersections of the plurality of scanning lines and the plurality of data lines,
when refreshing only a part of the plurality of pixels, the method comprising:
during a first period, selecting the scanning lines connected to part of the pixels and inputting display image data to the part of the pixels through the data lines; and
during a second period, selecting the scanning lines which are not connected to the part of the pixels,
wherein a period in which the respective scanning lines are selected during the second period is shorter than a period in which the respective scanning lines are selected during the first period.

2. The method according to claim 1,
wherein the electro-optical device includes:
a data line drive circuit that drives the plurality of data lines;
a scanning line drive circuit that drives the plurality of scanning lines; and
a drive controller that controls the data line drive circuit and the scanning line drive circuit, and
wherein the drive controller does not output a drive signal for allowing the scanning line drive circuit to select the scanning lines in a period in which the respective scanning lines are to be selected during the second period.

3. The method according to claim 1,
wherein the electro-optical device includes:
a data line drive circuit that drives the plurality of data lines;
a scanning line drive circuit that drives the plurality of scanning lines; and
a drive controller that controls the data line drive circuit and the scanning line drive circuit, and
wherein the drive controller controls the operation speed of the scanning line drive circuit so that the operation speed of the scanning line drive circuit during the second period is faster than the operation speed of the scanning line drive circuit during the first period.

4. The method according to claim 1,
wherein the electro-optical device includes:
a data line drive circuit that drives the plurality of data lines;
a scanning line drive circuit that drives the plurality of scanning lines; and
a drive controller that controls the data line drive circuit and the scanning line drive circuit, and
wherein the drive controller controls the potential of data for each pixel row using the data line drive circuit so that the potential of data to be written to the pixels during the second period is not changed.

5. The method according to claim 4,
wherein the drive controller inputs data of a specific potential to the part of the pixels before controlling the potential of data for each pixel row using the data line drive circuit during the second period.

6. The method according to claim 5.
wherein the drive controller controls the specific potential so as to be approximately the same as the potential of a common electrode applied in common to the plurality of pixels.

7. The method according to claim 1,
wherein a period up to the completion of the selecting of all the scanning lines during the first and second periods is fixed to a predetermined period regardless of the number of scanning lines driven during the first period.

8. The method according to claim 7,
wherein a period in which the respective scanning lines are selected during the first period and a period in which the respective scanning lines are selected during the second period are changed, whereby the period up to the completion of the selecting of all the scanning lines during the first and second periods is fixed to the predetermined period regardless of the number of scanning lines driven during the first period.

9. The method according to claim 7,
wherein a blanking period is inserted before or after the first and second periods, whereby the period up to the completion of the selecting of all the scanning lines during the first and second periods is fixed to the predetermined period regardless of the number of scanning lines driven during the first period.

10. The method according to claim 1,
wherein the first and second periods are repeated a plurality of times.

11. A method of driving an electro-optical device, the electro-optical device including:
a plurality of scanning lines;
a plurality of data lines intersecting the plurality of scanning lines; and
a plurality of pixels arranged at positions corresponding to the intersections of the plurality of scanning lines and the plurality of data lines,
when refreshing only a part of the plurality of pixels, the method comprising:
during a first period, selecting the scanning lines connected to part of the pixels and inputting display image data to the part of the pixels through the data lines; and
during a second period, selecting the scanning lines which are not connected to the part of the pixels,
wherein in a period in which the respective scanning lines are selected during the second period, a drive signal is not supplied to the scanning lines.

12. An electro-optical device comprising:
a plurality of scanning lines;
a plurality of data lines intersecting the plurality of scanning lines;
a plurality of pixels arranged at positions corresponding to the intersections of the plurality of scanning lines and the plurality of data lines;
a data line drive circuit that drives the plurality of data lines;
a scanning line drive circuit that drives the plurality of scanning lines; and
a drive controller that controls the data line drive circuit and the scanning line drive circuit,
wherein, when refreshing only a part of the plurality of pixels, the drive controller executes:
during a first period, selecting the scanning lines connected to part of the pixels and inputting display image data to the part of the pixels through the data lines; and
during a second period, selecting the scanning lines which are not connected to the part of the pixels, and
wherein a period in which the respective scanning lines are selected during the second period is shorter than a period in which the respective scanning lines are selected during the first period.

13. An electro-optical device comprising:
a plurality of scanning lines;
a plurality of data lines intersecting the plurality of scanning lines;
a plurality of pixels arranged at positions corresponding to the intersections of the plurality of scanning lines and the plurality of data lines;
a data line drive circuit that drives the plurality of data lines;
a scanning line drive circuit that drives the plurality of scanning lines; and
a drive controller that controls the data line drive circuit and the scanning line drive circuit,
wherein, when refreshing only a part of the plurality of pixels, the drive controller executes:
during a first period, selecting the scanning lines connected to part of the pixels and inputting display image data to the part of the pixels through the data lines; and
during a second period, selecting the scanning lines which are not connected to the part of the pixels, and
wherein the drive controller does not output a drive signal in a period in which the respective scanning lines are to be selected during the second period.

14. The electro-optical device according to claim 12,
wherein the pixels are made up of a display element containing a material having a memory effect.

15. The electro-optical device according to claim 14,
wherein the material having the memory effect includes an electrophoretic element.

16. The electro-optical device according to claim 15, further comprising a position detector that detects the position of pixels which are in contact with a pointer when the pointer is brought into contact with an arbitrary position of the plurality of pixels,
wherein the drive controller determines the scanning lines selected in the second step based on the position information of the pixels detected by the position detector.

17. An electronic apparatus comprising the electro-optical device according to claim 12.

18. An electronic apparatus comprising the electro-optical device according to claim 13.
